(19) United States
(12) Patent Application Publication
(10) Pub. No.: US 2026/0089696 A1
(43) Pub. Date: Mar. 26, 2026

(54) TRIGGER FRAME WITH SECURITY USER INFO FIELD

(71) Applicant: NXP USA, Inc., AUSTIN, TX (US)

(72) Inventors: Liwen Chu, San Ramon, CA (US); Kiseon Ryu, San Diego, CA (US); Huizhao Wang, San Jose, CA (US); Ken Kinwah Ho, San Jose, CA (US); Hongyuan Zhang, Fremont, CA (US)

(21) Appl. No.: 19/337,546

(22) Filed: Sep. 23, 2025

Related U.S. Application Data
(60) Provisional application No. 63/698,474, filed on Sep. 24, 2024.
(60) Provisional application No. 63/752,124, filed on Jan. 31, 2025.

(51) Int. Cl. H04W 72/0446; H04L 1/1607; H04W 72/21

(52) U.S. Cl. CPC H04W 72/0446; H04L 1/1642; H04W 72/21

(57) ABSTRACT

Methods and apparatus are described for generating Trigger frames including specialized User Info fields. In an example method, a first device generates a Trigger frame for soliciting a responsive physical layer (PHY) protocol data unit (PPDU). The Trigger frame of includes at least one User Info field carrying uplink scheduling information for at least one recipient wireless device. The Trigger frame further includes a plurality of Security User Info fields, the plurality of Security User Info fields carrying a packet number (PN) and message integrity check (MIC) value (PN+MIC value). In other examples, the Trigger frame may include User Info fields carrying an intermediate Frame Check Sequence (I-FCS) and/or feedback information. The first device subsequently transmits the Trigger frame for reception by the at least one recipient wireless device.

### CROSS REFERENCE TO RELATED APPLICATIONS

The present U.S. Utility Patent Application claims priority pursuant to 35 U.S.C. § 119(e) to U.S. Provisional Application No. 63/698,474, entitled “TRIGGER FRAME DESIGN-SECURITY USER INFO FIELD, FEEDBACK USER INFO FIELD”, filed Sep. 24, 2024, and U.S. Provisional Application No. 63/752,124, entitled “INTERMEDIATE FCS EXCHANGE”, filed Jan. 31, 2025, both of which are hereby incorporated herein by reference in their entirety and made part of the present U.S. Utility Patent Application for all purposes.

### TECHNICAL FIELD

This disclosure relates generally wireless communications, and more particularly, to frame formats for providing security and feedback information in Trigger frames used in wireless communications.

### BACKGROUND

Wireless local area networks (WLANs) have evolved rapidly over the past couple of decades, including WLANs that conform to the Institute of Electrical and Electronics Engineers (IEEE) 802.11 family of standards. A typical 802.11-based WLAN may be formed by one or more access points (APs) that provide a shared wireless communication medium for servicing a number of client devices or stations (STAs). In particular, an AP manages a Basic Service Set (BSS) that is identified by a Basic Service Set Identifier (BSSID) and advertised by the AP. The AP periodically broadcasts beacon frames to enable STAs within wireless range of the AP to establish and maintain communication links with the AP.

More recent versions of the IEEE 802.11 standards have added support for Trigger-based uplink communications to enhance network throughput. For example, the 802.11ax amendment to the IEEE 802.11 standard introduced a Trigger frame format that can be used to solicit Trigger-based (TB) physical layer (PHY) protocol data units (PPDUs) from one or more client devices. A Trigger frame can allocate wireless channel resources for uplink transmission of the TB PPDUs and indicate to client devices how the TB PPDUs are to be configured. The capabilities of the Trigger frame format were enhanced in the 802.11be amendment to the IEEE 802.11 standard to accommodate new features and capabilities introduced by the amendment.

### BRIEF DESCRIPTION OF THE DRAWINGS

FIG. 1 illustrates an example of a multi-link communications system in accordance with embodiments of the present disclosure;

FIG. 2 illustrates an example of a Trigger frame format including a packet number (PN) and message integrity check (MIC) value (PN+MIC value) carried in Security User Info fields in accordance with embodiments of the present disclosure;

FIG. 3 depicts another example of a Trigger frame format including a PN+MIC value carried in six Security User Info fields in accordance with embodiments of the present disclosure;

FIG. 4 depicts an example of a Trigger frame format including a Feedback User Info field and an intermediate Frame Check Sequence (I-FCS) User Info field in accordance with embodiments of the present disclosure;

FIG. 5 illustrates another example of a Trigger frame format including a PN+MIC value carried in seven Security User Info fields in accordance with embodiments of the present disclosure;

FIG. 6 illustrates another example of a Trigger frame format including a PN+MIC value in which the MIC portion begins on an octet boundary in accordance with embodiments of the present disclosure;

FIG. 7 illustrates another example of a Trigger frame format including a PN+MIC value carried in seven Security User Info fields in accordance with embodiments of the present disclosure;

FIG. 8 illustrates another example of a Trigger frame format including a PN+MIC value carried in five Security User Info fields in accordance with embodiments of the present disclosure;

FIG. 9 illustrates another example of a Trigger frame format including a PN+MIC value carried in six Security User Info fields in accordance with embodiments of the present disclosure an example of a Trigger frame padding field including an intermediate FCS value in accordance with embodiments of the present disclosure;

FIG. 10 illustrates a further example of a Trigger frame format including a PN+MIC value carried in six Security User Info fields in accordance with embodiments of the present disclosure;

FIG. 11 illustrates an example of a Trigger frame format including a Feedback User Info field with 28 bits carrying feedback information in accordance with embodiments of the present disclosure;

FIG. 12 illustrates an example of Trigger frame format including multiple Feedback User Info fields in accordance with embodiments of the present disclosure;

FIG. 13 illustrates additional examples of a Trigger frame format including one or more Feedback User Info field(s) carrying feedback information in accordance with embodiments of the present disclosure;

FIG. 14 illustrates examples of a Trigger frame format including an I-FCS Location User Info field in accordance with embodiments of the present disclosure;

FIG. 15 illustrates examples of a Trigger frame format in which one or more bits of a Common Info field or Special User Info field are repurposed as an I-FCS Location field in accordance with embodiments of the present disclosure;

FIG. 16 illustrates examples of a Trigger frame format having an I-FCS Location User Info field in which the location of an I-FCS User Info field is expressed in units of octets or a number of User Info fields of a User Info List;

FIG. 17 is a flow chart illustrating an example method for generating a Trigger frame in accordance with embodiments of the present disclosure; and

FIG. 18 illustrates an example of a wireless device according to embodiments of the present disclosure.

### DETAILED DESCRIPTION

The various implementations described in the following description relate generally to Trigger-based communications to support new wireless communication protocols, and more particularly to Trigger frame formats that support wireless communication features associated with the IEEE 802.11bn amendment (also referred to as Ultra High Reliability or “UHR” or “Wi-Fi 8”), and future generations, of the IEEE 802.11 standard.

In an example method according to the present disclosure, a Trigger frame is generated by a first device for soliciting a responsive physical layer (PHY) protocol data unit (PPDU). The Trigger frame of this example includes at least one User Info field carrying uplink scheduling information for at least one recipient wireless device, and further includes one or more of: a plurality of Security User Info fields carrying a packet number (PN) and message integrity check (MIC) value (PN+MIC value); an intermediate Frame Check Sequence (I-FCS) User Info field carrying an I-FCS value; and feedback/dynamic control information. The Trigger frame is then transmitted for reception by the at least one recipient wireless device. Specific examples of Trigger frame formats and specialized User Info fields according to the present disclosure are described more fully below.

As used herein, the term “non-legacy” may refer to PPDU formats and communication protocols conforming with the IEEE 802.11bn amendment to the IEEE 802.11 standard (“802.11bn”) as well as future generations/amendments. In contrast, the term “legacy” may be used herein to refer to PPDU formats and communication protocols conforming to the IEEE 802.11be (also referred to as Extremely High Throughput or “EHT” or “Wi-Fi 7”) or IEEE 802.11ax (also referred to as High Efficiency or “HE” or “Wi-Fi 6/6E”) amendments to the IEEE 802.11 standard, or earlier generations of the IEEE 802.11 standard, but not conforming to all mandatory features of 802.11bn or future generations of the IEEE 802.11 standard. In some implementations, a UHR Trigger frame may be configurable to support multiple versions of the IEEE 802.11 standard. For example, a UHR Trigger frame may be configured in accordance with a non-legacy Trigger frame format or a legacy Trigger frame format (e.g., to solicit a legacy TB PPDU from one or more STAs).

Particular implementations of the subject matter described in the present disclosure can be implemented to realize one or more of the following potential advantages. By improving and expanding security and control information exchange capabilities, the described frame formats and methods enhance support for networking features such as enhanced power saving features, in-device (radio) coexistence features, per TXOP Tx/Rx parameter negotiation and TXOP allocations, etc. Further, the novel frame formats described herein can be defined for use in existing Control frame types, thereby avoiding the need to define a new Control frame(s). In addition, the frame formats and methods described herein help enable gains in overall network throughput (particularly in high-density environments) that will be achievable in accordance with the IEEE 802.11bn amendment of the IEEE 802.11 standard.

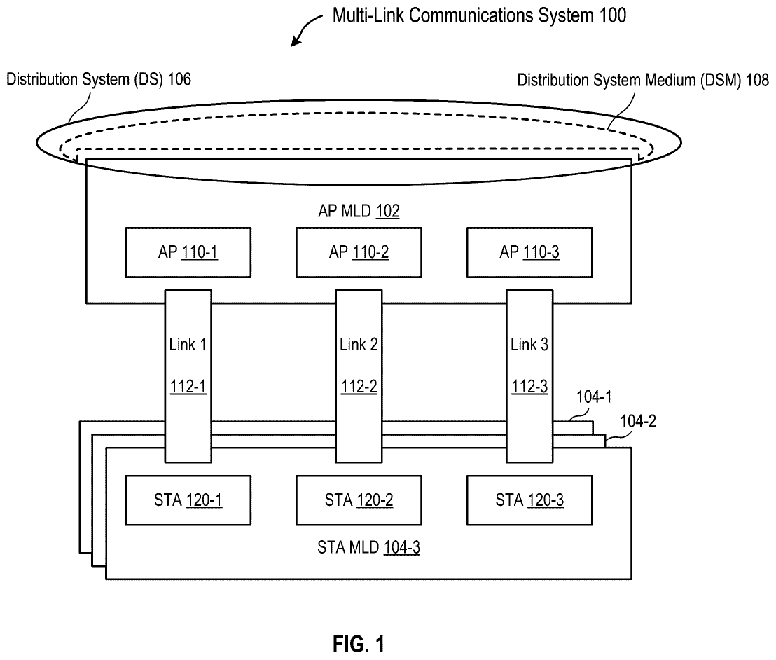

FIG. 1 illustrates an example of a multi-link (ML) communications system 100 in accordance with embodiments of the present disclosure. The illustrated multi-link communications system 100 includes at least one AP multi-link device (MLD) 102 and one or more non-AP multi-link devices (which may also be referred to as a “non-AP MLD” or “STA MLD”), which are, for example, implemented as station (STA) MLDs 104-1, 104-2, and 104-3. The multi-link communications system 100 can be used in various applications, such as industrial applications, medical applications, computer applications, and/or consumer or appliance applications. In the illustrated example, the multi-link communications system is a wireless communications system compatible with an IEEE 802.11 standard. Although the depicted multi-link communications system 100 is shown in FIG. 1 with certain components and described with certain functionality herein, other embodiments of the multi-link communications system 100 may include fewer or more components to implement the same, less, or more functionality. For example, although the multi-link communications system 100 shown in FIG. 1 includes the AP MLD 102 and the STA MLDs 104-1, 104-2, and 104-3, in other embodiments, the multi-link communications system includes other multi-link devices, such as, multiple AP MLDs and multiple STA MLDs, a single AP MLD and a single STA MLD. In another example, the multi-link communications system includes more than three STA MLDs and/or less than three STA MLDs. Although the multi-link communications system 100 is shown in FIG. 1 as being connected in a certain topology, the network topology of the multi-link communications system 100 is not limited to the topology shown in FIG. 1.

In the embodiment depicted in FIG. 1, the AP MLD 102 includes multiple radios, implemented as APs 110-1, 110-2, and 110-3. In some embodiments, the AP MLD 102 is an AP multi-link logical device or an AP multi-link logical entity (MLLE). In some embodiments, a common part of the AP MLD 102 implements upper layer Media Access Control (MAC) functionalities (e.g., beaconing, association establishment, reordering of frames, etc.) and a link specific part of the AP MLD 102, i.e., the APs 110-1, 110-2, and 110-3, implement lower layer MAC functionalities (e.g., backoff, frame transmission, frame reception, etc.). The APs 110-1, 110-2, and 110-3 may be implemented in hardware (e.g., circuits), software, firmware, or a combination thereof. At least one of the APs 110-1, 110-2, or 110-3 may be fully or partially implemented as an integrated circuit (IC) device. In some embodiments, the AP MLD and its affiliated APs 110-1, 110-2, and 110-3 are compatible with at least one WLAN communications standard (e.g., at least one IEEE 802.11 standard). For example, the APs 110-1, 110-2, and 110-3 may be wireless APs compatible with at least one non-legacy IEEE 802.11 standard.

In some embodiments, an AP MLD (e.g., the AP MLD 102) is connected to a local network (e.g., a local area network (LAN)) and/or to a backbone network (e.g., the Internet) through a wired connection and wirelessly connects to wireless STA MLDs, for example, through one or more WLAN communications standards, such as an IEEE 802.11 standard. In some embodiments, an AP (e.g., the AP 110-1, the AP 110-2, and/or the AP 110-3) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. The at least one controller may be implemented within a processor, such as a microcontroller, a host processor, a host, a digital signal processor (DSP), processing module, or a central processing unit (CPU), which can be integrated in a corresponding transceiver.

Each of the APs 110-1, 110-2, and 110-3 of the AP MLD 104 may operate in the same or different frequency bands. For example, at least one of the APs 110-1, 110-2, or 110-3 of the AP MLD 104 operates in an Extremely High Frequency (EHF) band or the “millimeter wave (mmWave)” frequency band. In some embodiments, a mmWave link may operate in a 45 GHz or 60 GHz frequency band. In a specific example, the AP 110-1 may operate in a 6 GHz band (e.g., with a 320 MHz Basic Service Set (BSS) operating channel or other suitable BSS operating channel), the AP 110-2 may operate in a 2.4/5 GHz band (e.g., with a 20/40/80/160 MHz BSS operating channel or other suitable BSS operating channel), and the AP 110-3 may operate in a 60 GHz band (e.g., with a 160 MHz BSS operating channel or other suitable BSS operating channel).

In the illustrated embodiment, the AP MLD is connected to a distribution system (DS) 106 through a distribution system medium (DSM) 108. The distribution system (DS) 106 may be a wired network or a wireless network that is connected to a backbone network such as the Internet. The DSM 108 may be a wired medium (e.g., Ethernet cables, telephone network cables, or fiber optic cables) or a wireless medium (e.g., infrared, broadcast radio, cellular radio, or microwaves). Although the AP MLD 102 is shown in FIG. 1 as including three APs, other embodiments of the AP MLD 102 may include fewer than three APs or more than three APs. In addition, although some examples of the DSM 108 are described, the DSM 108 is not limited to the examples described herein.

In the embodiment depicted in FIG. 1, the STA MLD 104-1 (non-AP MLD) includes radios, which are implemented as multiple non-AP stations (STAs) 120-1, 120-2, and 120-3. The STAs 120-1, 120-2, and 120-3 may be implemented in hardware (e.g., circuits), software, firmware, or a combination thereof. At least one of the STAs 120-1, 120-2, and 120-3 may be fully or partially implemented as an IC device. In some embodiments, the non-AP STAs 120-1, 120-2, and 120-3 are part of the STA MLD 104-1, such that the STA MLD may be a communications device that wirelessly connects to an AP MLD, such as, the AP MLD 102. For example, the STA MLD 104-1 (e.g., at least one of the non-AP STAs 120-1, 120-2 or 120-3) may be implemented in a laptop, a desktop computer, a mobile phone, or other communications device that supports at least one WLAN communications standard. In some embodiments, the STA MLD and its affiliated STAs 120-1, 120-2, and 120-3 are compatible with at least one IEEE 802.11 standard. In an example, each of the non-AP STAs 120-1, 120-2, and 120-3 includes at least one antenna, at least one transceiver operably connected to the at least one antenna, and at least one controller connected to the corresponding transceiver. The at least one transceiver may include a PHY device. The at least one controller can be configured to control the at least one transceiver to process received packets through the at least one antenna. In some embodiments, the at least one controller is implemented by a processor, such as a microcontroller, a host processor, a host, a DSP, processing module, or a CPU, which can be integrated in a corresponding transceiver. In an example, the STA MLD has one MAC data service interface. In another example, a single address is associated with the MAC data service interface and is used to communicate on the DSM 108. In some embodiments, the STA MLD 104-1 implements a common MAC data service interface and the non-AP STAs 120-1, 120-2, and 120-3 implement a lower layer MAC data service interface.

In an example, the AP MLD 102 and/or the STA MLDs 104-1, 104-2, and 104-3 identify which communications links support the multi-link operation during a multi-link operation setup phase and/or exchanges information regarding multi-link capabilities during the multi-link operation setup phase. In addition, each of the STAs 120-1, 120-2, and 120-3 of the STA MLD may operate in the same frequency band or different frequency bands. For example, at least one of the STAs 120-1, 120-2, or 120-3 of the STA MLD 104-1 operates in the mmWave frequency band (e.g., a 45 GHz or 60 GHz frequency band). In an example, the STA 120-1 may operate in a 6 GHz band (e.g., with a 320 MHz BSS operating channel or other suitable BSS operating channel), the STA 120-2 may operate in a 2.4/5 GHz band (e.g., with a 20/40/80/160 MHz BSS operating channel or other suitable BSS operating channel), and the STA 120-3 may operate in a 60 GHz band (e.g., with a 640 MHz BSS operating channel or other suitable BSS operating channel). Although the STA MLD 104-1 is shown in FIG. 1 as including three non-AP STAs, other embodiments of the STA MLD 104-1 may include fewer than three non-AP STAs or more than three non-AP STAs.

Each of the MLDs 104-2, 104-3 may be the same as or similar to the STA MLD 104-1. For example, the MLD 104-2 and 104-3 include one or multiple non-AP STAs. In some embodiments, each of the non-AP STAs includes at least one antenna, at least one transceiver operably connected to the at least one antenna, and at least one controller connected to the corresponding transceiver. In some embodiments, the at least one transceiver includes a PHY device. The at least one controller can be configured to control the at least one transceiver to process received packets through the at least one antenna. In some embodiments, the at least one controller is implemented by a processor, such as a microcontroller, a host processor, a host, a DSP, a processing module, or a CPU, which can be integrated in a corresponding transceiver.

In the illustrated network, the STA MLD 104-1 communicates with the AP MLD 102 through multiple communications links 112-1, 112-2, 112-3. For example, each of the STAs 120-1, 120-2, 120-3 communicates with an AP 110-1, 110-2, or 110-3 through a corresponding wireless communications link 112-1, 112-2, or 112-3. Although the AP MLD 102 communicates (e.g., wirelessly communicates) with the STA MLD 104-1 through multiple links 112-1, 112-2, 112-3, in other embodiments, the AP MLD 102 may communicate (e.g., wirelessly communicate) with the STA MLD through more than three communications links or less three than communications links. In some embodiments, the wireless communications links in the multi-link communications system include one or more 2.4 GHz, 5 GHz, 6 GHz, 45 GHz and/or 60 GHz links.

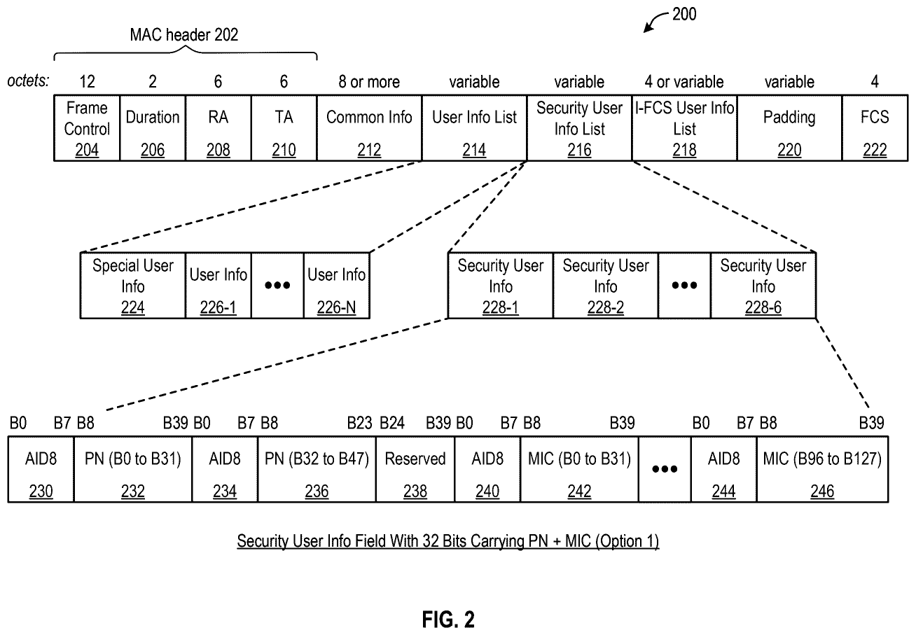

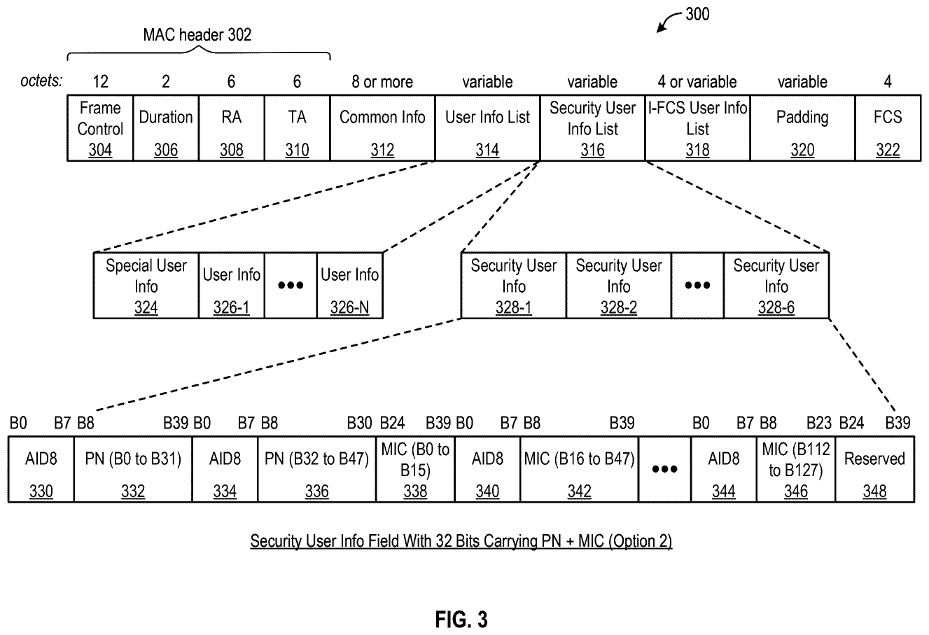

FIG. 2 illustrates an example of a Trigger frame 200 format including a packet number (PN) and message integrity check (MIC) value (PN+MIC value) carried in Security User Info fields in accordance with embodiments of the present disclosure. The PN+MIC value can be included in Trigger frame 200 to provide security parameters (e.g., a frame counter value) and is designed to prevent packet eavesdropping and spoofing, such as “man in the middle” attacks. In the illustrated example, the Trigger frame 200 is a protected Trigger frame (e.g., when some or all of the STAs addressed by the Trigger frame support protected Trigger frames) and the PN+MIC value is carried in six User Info fields (individually referred to as a “Security User Info field”). Various other arrangements of a PN+MIC value carried in Security User Info fields are described with reference to FIG. 3 and FIGS. 5-10.

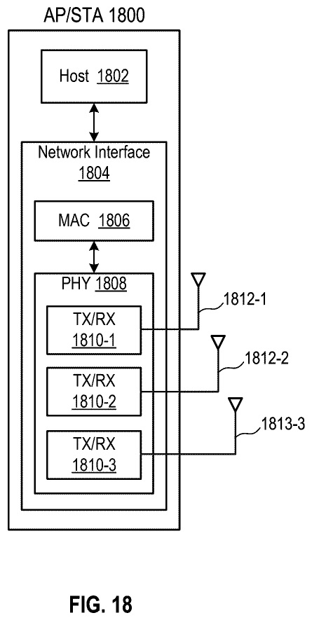

In an example, the Trigger frame 200 is a MAC Control frame included in a PPDU generated by an access point or a STA (e.g., an AP affiliated with the AP MLD 102 or a STA affiliated with the STA MLD 104 described with reference to FIG. 1, or the wireless device 1800 described with reference to FIG. 18), and can be transmitted to one STA/AP or a plurality of client STAs (i.e., recipient wireless device(s)). In addition to security-related information, the Trigger frame 200 may include resource unit allocation indications and other transmission parameters to be used for transmission of an uplink OFDMA or UL MU MIMO data unit during a transmit opportunity (TXOP). The Trigger frame 200 may be included in a PPDU that conforms with the IEEE 802.11bn, 802.11be, 802.11ax or other amendment(s) to the IEEE 802.11 standard. In some examples, the Trigger frame 200 can be used by a non-AP STA to solicit a non-TB PPDU(s) carrying various feedback control information in a Control frame. The Trigger frame 200 of this embodiment may include additional or modified fields/subfields as specified in the IEEE 802.11bn amendment (and other future amendments) to the 802.11 standard to accommodate new features and capabilities while maintaining backwards compatibility with earlier versions of the 802.11 standard.

The illustrated Trigger frame 200 includes a MAC header 202, a Common Information (“Common Info”) field 212, a User Information (“User Info”) List 214, a Security User Info List 216, an intermediate Frame Check Sequence (I-FCS) User Info field 218, a Padding field 220, and a Frame Check Sequence (FCS) field 222. The MAC header 202 includes a Frame Control field 204, a Duration field 206 (containing information for timing synchronization or identification), a receiver address (RA) field 208, and a transmitter address (TA) field 210. In an example, the Common Info field 212 and User Info List 214 carry configuration information which may be used by a receiving device to configure a TB PPDU that is transmitted in response to receiving the Trigger frame 200 (unless the Trigger frame solicits a non-TB PPDU). In an example, the User Info List 214 may include one or more User Information (“User Info”) fields 226-1 to 226-N, each of which carries per-User information for a respective user (e.g., uplink scheduling information), except for a Special User Info field 224 that carries information that is common for multiple or all recipients. The one or more User Info fields 226 may be addressed to UHR STAs and, in some examples, to EHT/HE STAs.

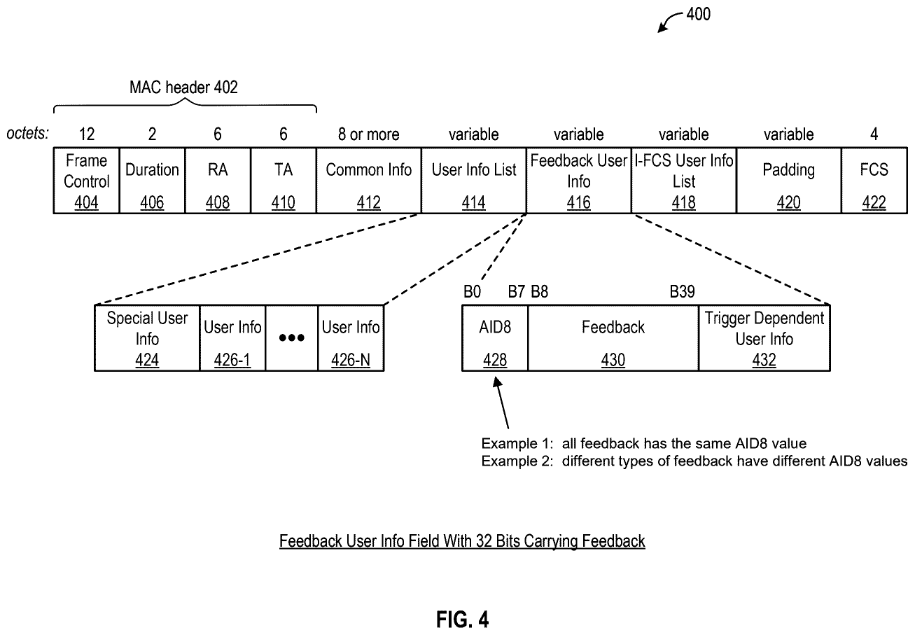

As described herein, the Trigger frame 200 can include one or more specialized User Info fields that carry information such as security information, an I-FCS value, and an I-FCS location. In addition, the Trigger frame 200 may include User Info fields that carry feedback information/dynamic (initial) control information (“Feedback User Info fields”), examples of which are described with reference to FIGS. 4 and 11-13. The Common Info field 212 may carry information (such as parameters for a TB PPDU transmission) that is common to all recipients (e.g., any users associated with User Info fields of the User Info List 214) of the Trigger frame 200. The number of octets of bits allocated to each field of the Trigger frame 200, according to this example, is indicated in FIG. 2 above the corresponding field.

In an example, the Frame Control field 204 includes a plurality of subfields including a type subfield indicating that the frame is a Control frame and a subtype subfield indicating a subtype (e.g., a value of 4 for a BSRP Trigger type) of the frame. In another example, the (legacy) FCS field 222 is a 32-bit field containing a 32-bit CRC value. The FCS is calculated over all the fields (i.e., “calculation fields”) of the MAC header and the frame body fields. The FCS value may be calculated and appended to a Trigger frame by an AP prior to transmission. In this example, the FCS field 222 is included to provide backward compatibility for communications with client devices that do not support non-legacy features that require intermediate FCS checking (e.g., IEEE 802.11ax STAs, 802.11be STAs, and UHR STAs that do not support the features that require intermediate FCS checking). Upon receipt of the Trigger frame by a recipient, the recipient can calculate an FCS value for the frame and compare it with the FCS value carried in the FCS field 222 of the received Trigger frame. If the two FCS values match, it is assumed that the frame was not corrupted during transmission. If the two FCS values are different, an error is assumed and the frame is discarded. In addition, the Trigger frame 200 may carry an intermediate FCS value(s) in one or more I-FCS User Info fields of an I-FCS User Info List 218 preceding the Padding field 220.

In part, the variable length Padding field 220 is present in the Trigger frame 200 to extend the frame length (1) to give the recipient STAs enough time to prepare a response (e.g., an Initial Control Response (ICR)) for transmission an SIFS after the Trigger frame is received and/or (2) to provide recipients sufficient time for a channel switch, an operating mode switch from a low capability mode to a high capability mode, etc. In alternate examples (not separately illustrated), one or more of a PN+MIC value, an I-FCS value, and feedback information may be included in a portion of the Padding field 220 (e.g., immediately following the first 16 bits (set to 1) of the padding).

The Special User Info field 224 is distinguished from a User Info field 226 by a special AID12 value (e.g., 2007). In an example, the Special User Info field 224 includes a PHY Version Identifier subfield value that can be set to identify a Trigger frame as an EHT variant Trigger frame or UHR variant Trigger frame. In the illustrated example, the I-FCS User Info field(s) of the I-FCS User Info List 218 may also be identified by a special AID12 value (e.g., 2006 or 2008) or range of values (e.g., greater than 2007), or a special AID8 value (such that a 4 octet intermediate FCS value can be carried in a single User Info field), and may be the last User Info field preceding the Padding field 220 when padding is required. In a further example, if the intermediate FCS value is carried in two User Info fields, a special AID8 or AID12 value is the same for both User Info fields. In another example, an I-FCS User Info field(s) of the I-FCS User Info List 218 has the same length as the Special User Info field 224.

In various of the embodiments described herein, the intermediate FCS value is calculated over all of the fields before the I-FCS User Info List 218. By including a separate intermediate FCS value(s) in a Trigger frame, a recipient UHR STA/AP may advantageously utilize it as a signal to stop decoding the Trigger frame (e.g., ignore any trailing padding bits and the conventional FCS value) if the recipient UHR STA implements certain features (e.g., a low capability mode, dynamic subband switching, etc.) that allow the recipient UHR STA to stop decoding a Trigger frame after checking an intermediate FCS field.

In the illustrated example, the Security User Info List 216 of Trigger frame 200 includes a plurality of Security User Info fields 228-1 to 228-N (e.g., where N=6). In each of the illustrated Security User Info fields 228, 32 bits are available to carry a portion of the PN+MIC value. For example, 8 bits of a corresponding AID12 subfield (labeled as “AID8” subfields) are used to indicate that a User Info field is a Security User Info field, and 4 bits of the AID12 subfield and B12 to B39 of the Security User Info field are used to carry a portion of PN+MIC value. If Trigger Dependent User Info fields exist, such fields are not used to carry the PN+MIC value.

In the illustrated example, a PN+MIC value (e.g., 48+128 bits) is carried in six consecutive Security User Info fields 228 of the Trigger frame 200. In this example, each of the PN value and MIC value starts in a new Security User Info field 228 (e.g., at an octet boundary). The first Security User Info field 228-1 includes an (8 bit) AID8 subfield 230 and the first 32 bits (B0 to B31) of the PN value. The second Security User Info field 228-2 includes an AID8 subfield 234 followed by the remaining bits 236 (B32-B47) of the PN value. In this example, bits 238 (B24-B39) of the Security User Info field 228-2 are reserved. A third Security User Info field 228-3 includes an AID8 subfield 240 followed by the first 32 bits of the MIC value (in subfield 242). Fourth and fifth Security User Info fields 228 (not separately illustrated) similarly carry the next 64 bits of the MIC value. A sixth Security User Info field 228-6 includes an AID8 subfield 244 followed by remaining bits B96-B127 (in subfield 246) of the MIC value. In another example, separate PN+MIC values may be similarly included in the Security User Info List 216 for each UHR STA addressed in the Trigger frame 200.

In the examples of FIG. 2 and FIG. 3, the values in the AID8 subfields of the various User Info fields are set to indicate whether a User Info field carries PN+MIC values, intermediate FCS values, or feedback information, and may be set to differing predetermined values (or a range of values) for each. In an example, such AID8 subfields may have values which, when combined with any values of 4 other bits (from 0 to 15) related to a complete AID12 subfield result in a combined value of more than 2007 but not more than 2047.

In some embodiments, a Trigger frame (e.g., an EHT or later variant Trigger frame) may include a Special User Info field having an appended Trigger Dependent User Info subfield. In this instance, when the Trigger frame further includes a Security User Info field, a Feedback User Info field, and/or an intermediate FCS (I-FCS) User Info field, such fields may further include an appended Trigger Dependent User Info subfield that follows the same rules and includes the same content as a Trigger Dependent User Info subfield of the Special User Info field. In addition, a Security User Info field, a Feedback User Info field, and/or an intermediate I-FCS User Info field may have the same length as the Special User Info field.

In further examples, a Trigger frame that is a protected Trigger frame may be identified by a number of indications. For example, an EHT variant Trigger frame that is a protected Trigger frame can be identified using reserved bits in a Special User Info field and/or Common User Info field. In an HE variant Trigger frame, however, the Common User Info field does not include reserved bits. As such, a protected Trigger frame should be an EHT, UHR, or later variant Trigger frame. In another example, a Trigger frame (e.g., a BSRP Trigger frame) can be configured as an Initial Control Frame (ICF). The ICF may include several indications including, for example, whether the ICF solicits a non-HT (duplicate) PPDU or non-TB PPDU. In a first option, only an EHT, UHR, or subsequent variant BSRP Trigger frame may be used as an ICF. In another option, any type of Trigger frame can be configured as an ICF.

FIG. 3 depicts another example of a Trigger frame 300 format including a PN+MIC value carried in six Security User Info fields in accordance with embodiments of the present disclosure. The illustrated Trigger frame 300 is similar in format to the Trigger frame 200 of FIG. 2, except that the MIC value begins immediately after the PN value in the Security User Info List 316.

In the illustrated example, the Trigger frame 300 includes a MAC header 302 having a Frame Control field 304, a Duration field 306, a RA field 308, and a TA field 310, a Common Info field 312, a User Info List 314, a Security User Info List 316, an intermediate Frame Check Sequence (I-FCS) User Info List 318, a Padding field 320, and an FCS field 322. In an example, the User Info List 314 may include a Special User Info field 324 and one or more User Info fields 326-1 to 326-N. The foregoing fields of Trigger frame 300 generally correspond to the similarly labeled fields 204-226 described with reference to FIG. 2.

In the illustrated example, the Security User Info List 316 includes a plurality of Security User Info fields 328-1 to 328-6. In each of the illustrated Security User Info fields 328, 32 bits are available to carry a portion of the PN+MIC value. In this example, a PN+MIC value (e.g., 48+128 bits) is carried in six consecutive Security User Info fields 328 of the Trigger frame 300. The first Security User Info field 328-1 includes an (8 bit) AID8 subfield 330 and the first 32 bits (B0 to B31) of the PN value. The second Security User Info field 328-2 includes an AID8 subfield 334 followed by the remaining bits 336 (B32-B47) of the PN value. In this example, the remaining bits 338 of the Security User Info field 328-2 carry the first 16 bits of the MIC value. A third Security User Info field 328-3 includes an AID8 subfield 340 followed by the next 32 bits of the MIC value (in subfield 342). Fourth and fifth Security User Info fields 328 (not separately illustrated) similarly carry the next 64 bits of the MIC value. A sixth Security User Info field 328-6 includes an AID8 subfield 344 followed by the remaining bits B112-B127 (in subfield 346) of the MIC value. In this example, the last 16 bits of the Security User Info field (subfield 348) are reserved. In another example, separate PN+MIC values may be similarly included in the Security User Info List 316 for each UHR STA addressed in the Trigger frame 300.

In various examples, if a Trigger frame according to the present disclosure carries one or more Feedback User Info fields, such fields may immediately follow the User Info fields that provide resource allocations (RU locations, etc.) to addressed STAs. If the Trigger frame also includes Security User Info fields carrying a PN+MIC value(s), such fields may immediately follow the Feedback User Info field(s). When the Trigger frame further includes an I-FCS User Info field(s), such fields may follow the Feedback User Info fields and/or Security User Info fields.

FIG. 4 depicts an example of a Trigger frame 400 format including a Feedback User Info field and an intermediate Frame Check Sequence (I-FCS) User Info field in accordance with embodiments of the present disclosure. In this example, the Feedback User Info field(s) 416 carries 32 bits of feedback information (e.g., unavailability information) of the transmitting device. Feedback information may include feedback control information (<MCS, Nss, BW> of the recipient in the TXOP, unavailable information, etc.).

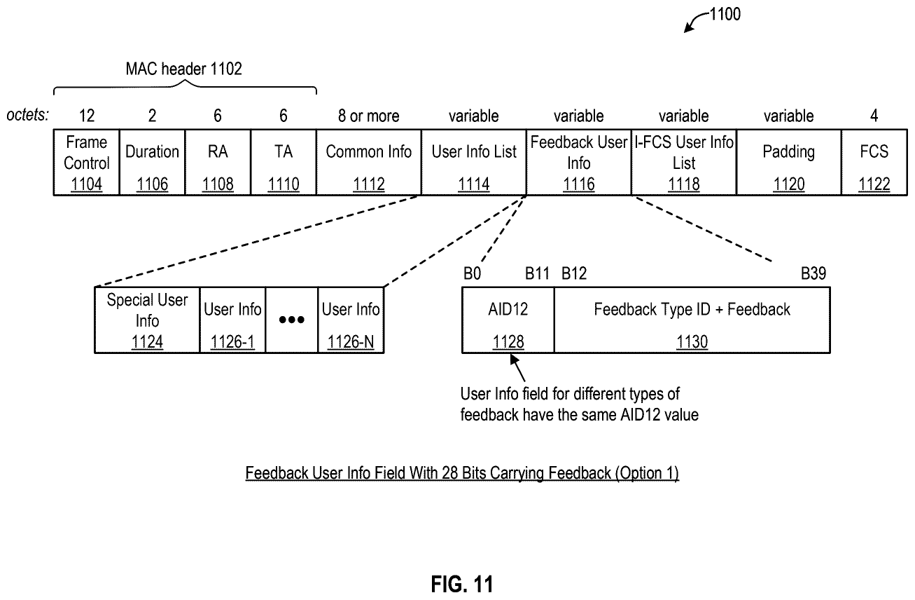

In the illustrated example, if Trigger frame protection is not required the PN+MIC value is omitted. In addition, multiple Feedback User Info fields 416 may be included in Trigger frame 400 to carry different types of feedback information, with each type of feedback information beginning in a new Feedback User Info field. Further, multiple Feedback User Info fields 416 may be included to carry particular feedback information that exceeds 32 bits in length. Additional examples of a Trigger frame including feedback information in accordance with the present disclosure are described with reference to FIGS. 11-13.

The Trigger frame 400 of this example includes a MAC header 402 having a Frame Control field 404, a Duration field 406, a RA field 408, and a TA field 410, a Common Info field 412, a User Info List 414, a Feedback User Info field 416, an intermediate Frame Check Sequence (I-FCS) User Info List 418, a Padding field 420, and an FCS field 422. In an example, the User Info List 414 may include a Special User Info field 424 and one or more User Info fields 426-1 to 426-N. The foregoing fields of Trigger frame 400 generally correspond to the similarly labeled fields 204-226 described with reference to FIG. 2.

In the illustrated example, the Feedback User Info field 416 includes an AID8 subfield 428, a feedback subfield 430 carrying 32 bits of feedback information, and an (optional) Trigger Dependent User Info subfield 432. If the Trigger Dependent User Info subfield 432 is present, it is not used to carry feedback information, and may follow the same rules and include the same content as a Trigger Dependent User Info subfield of the Special User Info field 424.

The illustrated AID8 subfield 428 carries a value that is used by a recipient device to identify a User Info field that carries feedback information. In an example, all types of feedback may be identified using the same AID8 value. In another example, different types of feedback information are identified by different AID8 values. In a further example, each Feedback User Info field 416 carries a Feedback Type ID (e.g., in subfield 430) followed by feedback information or remaining feedback information when a single Feedback User Info field is not sufficient to carry the feedback information. When multiple Feedback User Info fields are required for carrying one type of feedback information, padding may be included in the last Feedback User Info field as necessary.

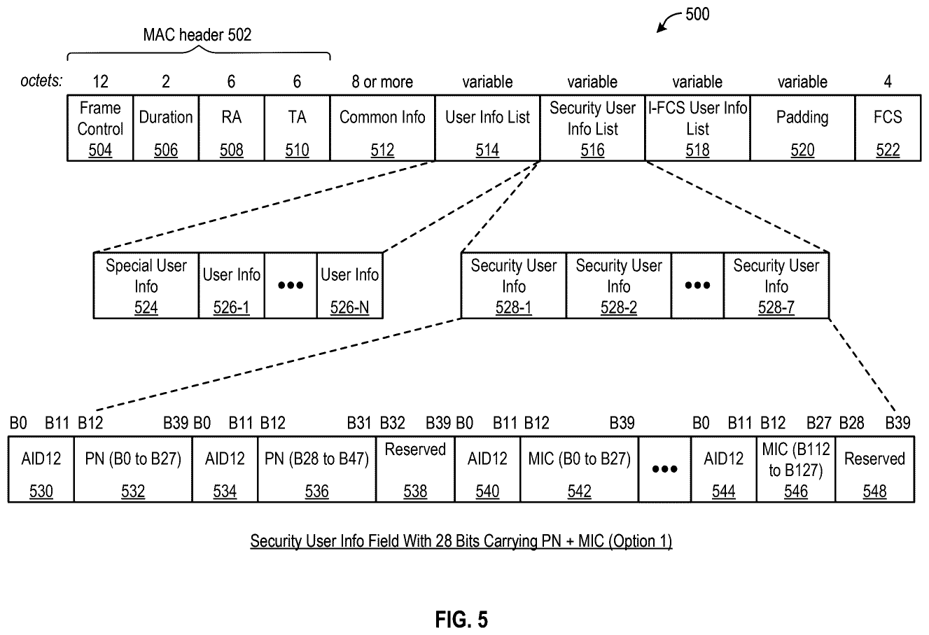

In the examples of FIGS. 5-10, the values in the AID 12 subfields of the various User Info fields are set to indicate whether a User Info field carries PN+MIC values, intermediate FCS values, or feedback information, and may be set to differing predetermined values (e.g., 2006 or 2008) or a range of values. In an example, such AID12 subfields may have values which are more than 2007. In another example, the AID12 values for the Security User Info fields including PN+MIC values may have a first predetermined value (e.g., 2005) and the AID12 values for the User Info fields including intermediate FCS values may have a second predetermined value (e.g., 2006 or 2008) or a range of values (e.g., ≥2008). In a further example, the AID12 values for various of the specialized User Info fields may correspond to the AID12 values of the associated UHR STAs.

FIG. 5 illustrates another example of a Trigger frame 500 format including a PN+MIC value carried in seven Security User Info fields in accordance with embodiments of the present disclosure. In the illustrated example, the Trigger frame 500 is a protected Trigger frame and the PN+MIC value is carried in seven User Info fields (“Security User Info fields”).

In the illustrated example, the Trigger frame 500 includes a MAC header 502 having a Frame Control field 504, a Duration field 506, a RA field 508, and a TA field 510, a Common Info field 512, a User Info List 514, a Security User Info List 516, an intermediate Frame Check Sequence (I-FCS) User Info List 518, a Padding field 520, and an FCS field 522. In an example, the User Info List 514 may include a Special User Info field 524 and one or more User Info fields 526-1 to 526-N. The foregoing fields of Trigger frame 500 generally correspond to the similarly labeled fields 204-226 described with reference to FIG. 2.

In this example, the Security User Info List 516 of Trigger frame 500 includes seven Security User Info fields 528-1 to 528-7. In each of the illustrated Security User Info fields 528, 28 bits are available to carry a portion of the PN+MIC value. If Trigger Dependent User Info fields exist, such fields are not used to carry the PN+MIC value. In this example, a PN+MIC value (e.g., 48+128 bits) is carried in consecutive Security User Info fields 528 of the Trigger frame 500, and each of the PN value and MIC value starts in a new Security User Info field 528. The first Security User Info field 528-1 includes an (12 bit) AID12 subfield 530 and the first 28 bits (B0 to B27) of the PN value. The second Security User Info field 528-2 includes an AID12 subfield 534 followed by the remaining bits 536 (B28-B47) of the PN value. In this example, the remaining bits (subfield 538) of the Security User Info field 528-2 are reserved. A third Security User Info field 528-3 includes an AID12 subfield 540 followed by the first 28 bits of the MIC value (in subfield 542). Fourth, fifth, and sixth Security User Info fields 528 (not separately illustrated) similarly carry the next 84 bits of the MIC value. A seventh Security User Info field 528-7 includes an AID2 subfield 544 followed by the remaining 16 bits B112-B127 of the MIC value (subfield 546). In this example, the last 12 bits of the Security User Info field 528-7 (subfield 548) are reserved. In another example, separate PN+MIC values may be similarly arranged in the Security User Info List 516 for each UHR STA addressed in the Trigger frame 500.

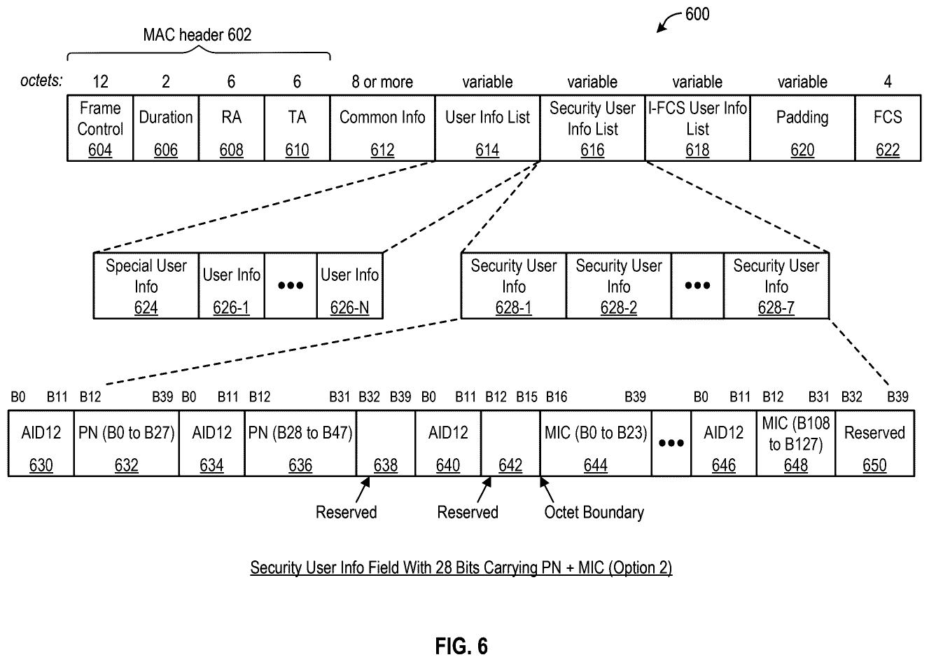

FIG. 6 illustrates another example of a Trigger frame 600 format including a PN+MIC value in which the MIC portion begins on an octet boundary in accordance with embodiments of the present disclosure. In particular, the illustrated Trigger frame 600 is similar in format to the Trigger frame 500 of FIG. 5, except that the MIC value begins at bit B16 of a Security User Info field 628.

In the illustrated example, the Trigger frame 600 includes a MAC header 602 having a Frame Control field 604, a Duration field 606, a RA field 608, and a TA field 610, a Common Info field 612, a User Info List 614, a Security User Info List 616, an intermediate Frame Check Sequence (I-FCS) User Info List 618, a Padding field 620, and an FCS field 622. In an example, the User Info List 614 may include a Special User Info field 624 and one or more User Info fields 626-1 to 626-N. The foregoing fields of Trigger frame 600 generally correspond to the similarly labeled fields 204-226 described with reference to FIG. 2.

In this example, the Security User Info List 616 of Trigger frame 600 includes seven Security User Info fields 628-1 to 628-7. In each of the illustrated Security User Info fields 628, 28 bits are available to carry a portion of the PN+MIC value. If Trigger Dependent User Info fields exist, such fields are not used to carry the PN+MIC value. In this example, a PN+MIC value (e.g., 48+128 bits) is carried in consecutive Security User Info fields 628 of the Trigger frame 600, and each of the PN value and MIC value starts in a new Security User Info field 628. The first Security User Info field 628-1 includes an AID12 subfield 630 and the first 28 bits (B0 to B27) of the PN value. The second Security User Info field 628-2 includes an AID12 subfield 634 followed by the remaining bits 636 (B28-B47) of the PN value. In this example, the remaining bits (subfield 638) of the Security User Info field 628-2 are reserved. A third Security User Info field 628-3 includes an AID12 subfield 640 followed by four reserved bits (subfield 642) and the first 24 bits of the MIC value (in subfield 644). In this example, the four reserved bits of subfield 642 function to align the beginning of the MIC value with an octet boundary. Fourth, fifth, and sixth Security User Info fields 628 (not separately illustrated) carry the next 84 bits of the MIC value. A seventh Security User Info field 628-7 includes an AID12 subfield 646 followed by the remaining 16 bits B112-B127 of the MIC value (subfield 648). In this example, the last 8 bits of the Security User Info field 628-7 (subfield 650) are reserved. In another example, separate PN+MIC values may be similarly arranged in the Security User Info List 616 for each UHR STA addressed in the Trigger frame 600.

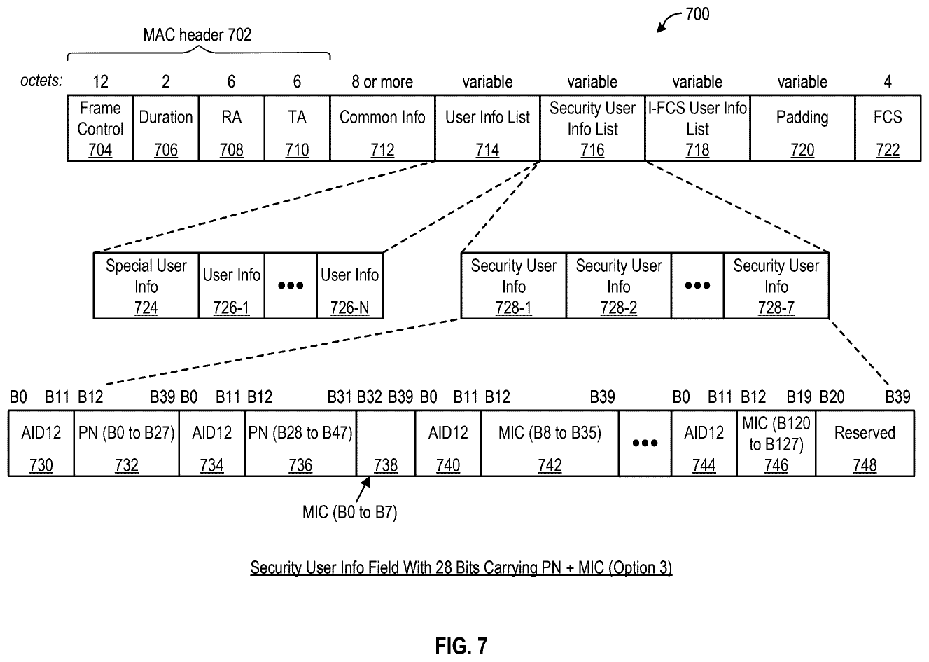

FIG. 7 illustrates another example of a Trigger frame 700 format including a PN+MIC value carried in seven Security User Info fields in accordance with embodiments of the present disclosure. The illustrated Trigger frame 700 is similar in format to the Trigger frame 500 of FIG. 5, except that the MIC value begins immediately after the PN value within the Security User Info List 716.

In the illustrated example, the Trigger frame 700 includes a MAC header 702 having a Frame Control field 704, a Duration field 706, a RA field 708, and a TA field 710, a Common Info field 712, a User Info List 714, a Security User Info List 716, an intermediate Frame Check Sequence (I-FCS) User Info List 718, a Padding field 720, and an FCS field 722. In an example, the User Info List 714 may include a Special User Info field 724 and one or more User Info fields 726-1 to 726-N. The foregoing fields of Trigger frame 700 generally correspond to the similarly labeled fields 204-226 described with reference to FIG. 2.

In this example, the Security User Info List 716 of Trigger frame 700 includes seven Security User Info fields 728-1 to 728-7. In each of the illustrated Security User Info fields 728, 28 bits are available to carry a portion of the PN+MIC value. If Trigger Dependent User Info fields exist, such fields are not used to carry the PN+MIC value. In this example, a PN+MIC value (e.g., 48+128 bits) is carried in consecutive Security User Info fields 728 of the Trigger frame 700. The first Security User Info field 728-1 includes an AID12 subfield 730 and the first 28 bits (B0 to B27) of the PN value. The second Security User Info field 728-2 includes an AID12 subfield 734 followed by the remaining bits 736 (B28-B47) of the PN value. In this example, the remaining bits (subfield 738) of the Security User Info field 728-2 carry the first 8 bits of the MIC value. A third Security User Info field 728-3 includes an AID12 subfield 740 followed by the next 28 bits of the MIC value (in subfield 742). Fourth, fifth, and sixth Security User Info fields 728 (not separately illustrated) similarly carry the next 84 bits of the MIC value. A seventh Security User Info field 728-7 includes an AID12 subfield 744 followed by the remaining 8 bits B120-B127 of the MIC value (subfield 746). In this example, the last 20 bits of the Security User Info field 728-7 (subfield 748) are reserved. In another example, separate PN+MIC values may be similarly arranged in the Security User Info List 716 for each UHR STA addressed in the Trigger frame 700.

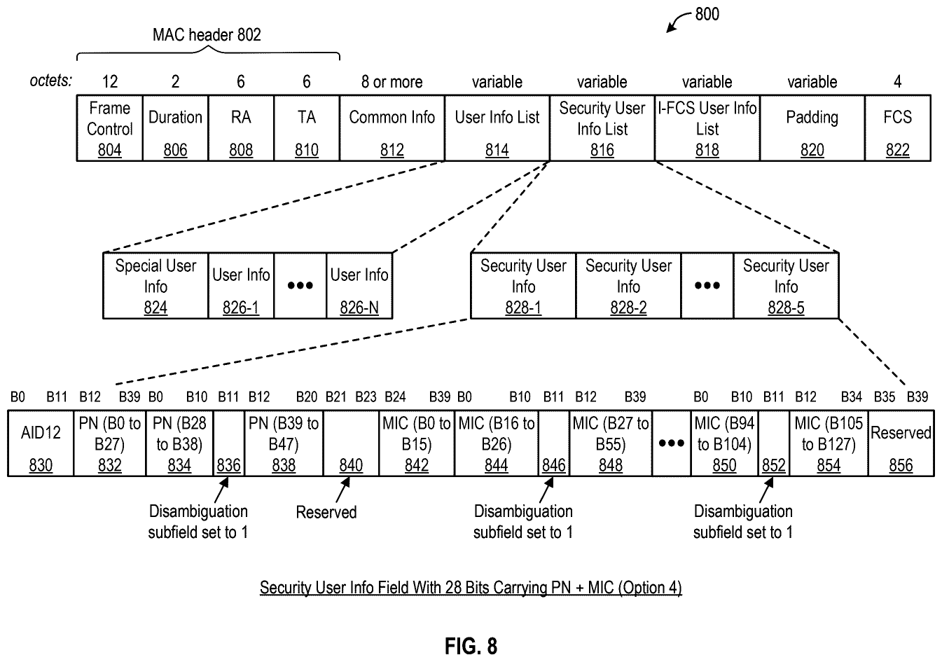

FIG. 8 illustrates another example of a Trigger frame 800 format including a PN+MIC value carried in five Security User Info fields in accordance with embodiments of the present disclosure. The illustrated Trigger frame 800 is similar in format to the Trigger frame 500 of FIG. 5, except that the only the first Security User Info field of the Security User Info list 816 includes an AID12 value, and the remaining four (instead of six) Security User Info fields are arranged to carry a greater number of bits of the PN+MIC value.

In the illustrated example, the Trigger frame 800 includes a MAC header 802 having a Frame Control field 804, a Duration field 806, a RA field 808, and a TA field 810, a Common Info field 812, a User Info List 814, a Security User Info List 816, an intermediate Frame Check Sequence (I-FCS) User Info List 818, a Padding field 820, and an FCS field 822. In an example, the User Info List 814 may include a Special User Info field 824 and one or more User Info fields 826-1 to 826-N. The foregoing fields of Trigger frame 800 generally correspond to the similarly labeled fields 204-226 described with reference to FIG. 2.

In this example, the Security User Info List 816 of Trigger frame 800 includes five Security User Info fields 828-1 to 828-5. If Trigger Dependent User Info fields exist, such fields are not used to carry the PN+MIC value. In this example, a PN+MIC value (e.g., 48+128 bits) is carried in consecutive Security User Info fields 828 of the Trigger frame 800. The first Security User Info field 828-1 includes an AID12 subfield 830 that indicates the presence of the PN+MIC value, and is followed by the first 28 bits (B0 to B27) of the PN value (subfield 832). In the second Security User Info field 828-2 of this example, the first 11 bits (subfield 834) are used to carry bits B28-B38 of the PN value, and bit 12 (subfield 836) is utilized as a disambiguation subfield that is set 1 to indicate that the Security User Info field 828-2 is a continuation of the Security User Info List 816 and that the remaining 39 bits carry PN+MIC information. The Security User Info field 828-2 further includes four reserved bits (subfield 840) followed by the first 16 bits (B0 to B15) of the MIC value (subfield 842). The four reserved bits of subfield 840 function to align the beginning of the MIC value with an octet boundary. In this example, a third Security User Info field 828-3 begins with the next 11 bits of the MIC value (subfield 844) followed by a (single bit) disambiguation subfield 846 set to 1. The third Security User Info field 828-3 further includes the next 28 bits (B27 to B55) of the MIC value (subfield 848). A fourth Security User Info field 828 (not separately illustrated) similarly carries the next 39 bits of the MIC value. A fifth Security User Info field 828-5 includes bits B94 to B104 of the MIC value (subfield 850) followed by a disambiguation subfield 852 set to 1 and the remaining bits B105 to B127 of the MIC value (subfield 854). In this example, the last 5 bits of the Security User Info field 828-5 (subfield 856) are reserved. In another example, separate PN+MIC values may be similarly arranged in the Security User Info List 816 for each UHR STA addressed in the Trigger frame 800.

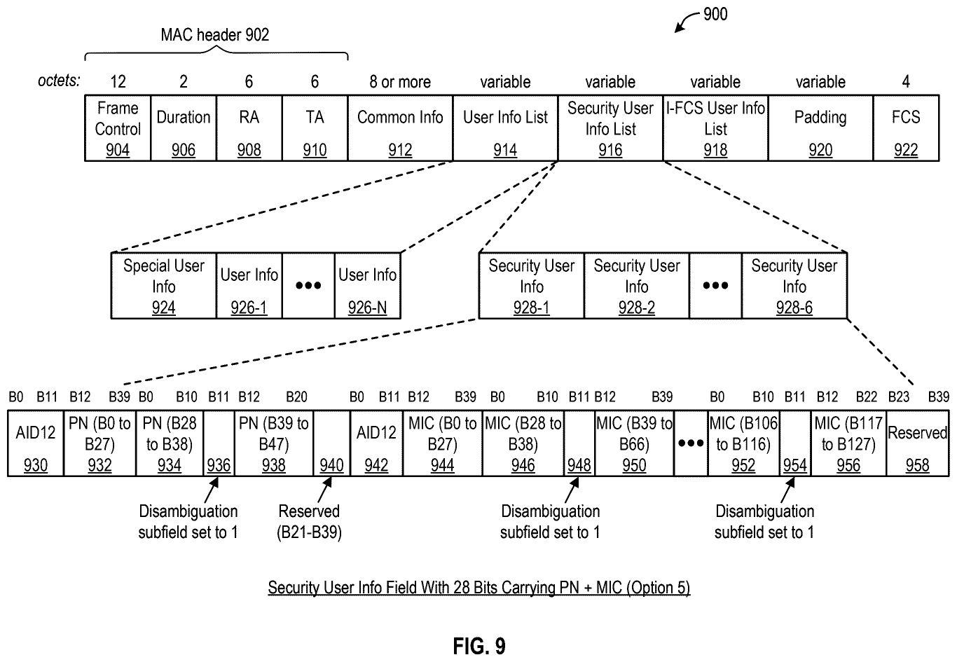

FIG. 9 illustrates another example of a Trigger frame 900 format including a PN+MIC value carried in six Security User Info fields in accordance with embodiments of the present disclosure. The illustrated Trigger frame 900 is similar in format to the Trigger frame 800 of FIG. 8, except that the PN value and the MIC value begin in separate Security User Info fields, the MIC value does not begin on an octet boundary, and the combined PN+MIC value is carried in six Security User Info fields.

In the illustrated example, the Trigger frame 900 includes a MAC header 902 having a Frame Control field 904, a Duration field 906, a RA field 908, and a TA field 910, a Common Info field 912, a User Info List 914, a Security User Info List 916, an intermediate Frame Check Sequence (I-FCS) User Info List 918, a Padding field 920, and an FCS field 922. In an example, the User Info List 914 may include a Special User Info field 924 and one or more User Info fields 926-1 to 926-N. The foregoing fields of Trigger frame 900 generally correspond to the similarly labeled fields 204-226 described with reference to FIG. 2.

In this example, the Security User Info List 916 of Trigger frame 900 includes six Security User Info fields 928-1 to 928-6. If Trigger Dependent User Info fields exist, such fields are not used to carry the PN+MIC value. In this example, a PN+MIC value (e.g., 48+128 bits) is carried in consecutive Security User Info fields 928 of the Trigger frame 900. The first Security User Info field 928-1 includes an AID12 subfield 930 that indicates the presence of the PN+MIC value, and is followed by the first 28 bits (B0 to B27) of the PN value (subfield 932). In the second Security User Info field 928-2 of this example, the first 11 bits (subfield 934) are used to carry bits B28-B38 of the PN value, and bit 12 (subfield 936) is utilized as a disambiguation subfield that is set 1 to indicate that the Security User Info field 928-2 is a continuation of the Security User Info List 916. The Security User Info field 928-2 further includes the remaining bits B39 to B47 of the PN value (subfield 938) and 20 reserved bits (subfield 940). In this example, a third Security User Info field 928-3 begins with an AID12 subfield 942 that indicates the beginning of the MIC value, and is followed by the first 28 bits of the MIC value (subfield 944). A fourth Security User Info field 928-4 of this example includes the next 11 bits B28 to B38 of the MIC value (subfield 946), followed by a disambiguation subfield 948 set to 1. The fourth Security User Info field 928-4 further includes the next 28 bits (B39 to B66) of the MIC value (subfield 950). A fifth Security User Info field 928 (not separately illustrated) similarly carries the next 39 bits of the MIC value. Continuing with this example, a sixth Security User Info field 928-6 includes bits B106 to B116 of the MIC value (subfield 952) followed by a disambiguation subfield 954 set to 1 and the remaining bits B117 to B127 of the MIC value (subfield 956). In this example, the remaining bits of the Security User Info field 928-6 (subfield 958) are reserved. In another example, separate PN+MIC values may be similarly arranged in the Security User Info List 916 for each UHR STA addressed in the Trigger frame 900.

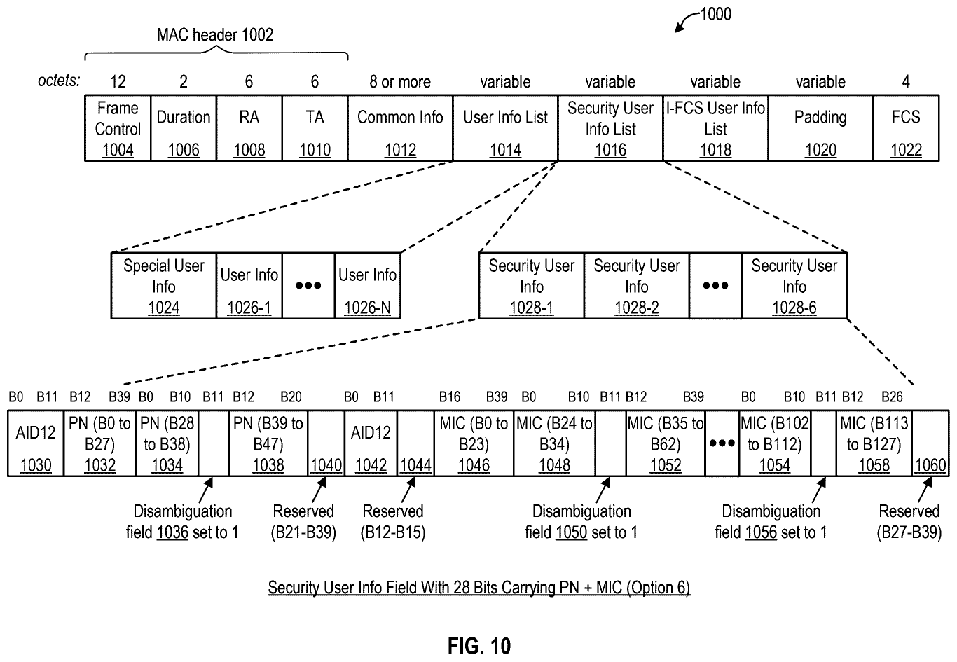

FIG. 10 illustrates a further example of a Trigger frame 1000 format including a PN+MIC value carried in six Security User Info fields in accordance with embodiments of the present disclosure. The illustrated Trigger frame 1000 is similar in format to the Trigger frame 900 of FIG. 9, except that the beginning of the MIC portion is aligned with an octet boundary.

In the illustrated example, the Trigger frame 1000 includes a MAC header 1002 having a Frame Control field 1004, a Duration field 1006, a RA field 1008, and a TA field 1010, a Common Info field 1012, a User Info List 1014, a Security User Info List 1016, an intermediate Frame Check Sequence (I-FCS) User Info List 1018, a Padding field 1020, and an FCS field 1022. In an example, the User Info List 1014 may include a Special User Info field 1024 and one or more User Info fields 1026-1 to 1026-N. The foregoing fields of Trigger frame 1000 generally correspond to the similarly labeled fields 204-226 described with reference to FIG. 2.

In this example, the Security User Info List 1016 of Trigger frame 1000 includes six Security User Info fields 1028-1 to 1028-6. If Trigger Dependent User Info fields exist, such fields are not used to carry the PN+MIC value. In this example, a PN+MIC value (e.g., 48+128 bits) is carried in consecutive Security User Info fields 1028 of the Trigger frame 1000. The first Security User Info field 1028-1 includes an AID12 subfield 1030 that signals the presence of the PN+MIC value, and is followed by the first 28 bits (B0 to B27) of the PN value (subfield 1032). In the second Security User Info field 1028-2 of this example, the first 11 bits (subfield 1034) are used to carry bits B28-B38 of the PN value, and bit 12 (subfield 1036) is utilized as a disambiguation subfield that is set 1 to indicate that the Security User Info field 1028-2 is a continuation of the Security User Info List 1016. The Security User Info field 1028-2 further includes the remaining bits B39 to B47 of the PN value (subfield 1038) and 20 reserved bits (subfield 1040). In this example, a third Security User Info field 1028-3 begins with an AID12 subfield 1042 that indicates the beginning of the MIC value, and further includes four reserved bits (subfield 1044) followed by the first 24 bits (B0 to B23) of the MIC value (subfield 1046). The four reserved bits of subfield 1044 function to align the beginning of the MIC value with an octet boundary.

A fourth Security User Info field 1028-4 of this example includes the next 11 bits B24 to B34 of the MIC value (subfield 1048), followed by a disambiguation subfield 1050 set to 1. The fourth Security User Info field 1028-4 further includes the next 28 bits (B35 to B62) of the MIC value (subfield 1052). A fifth Security User Info field 1028 (not separately illustrated) similarly carries the next 39 bits of the MIC value. Continuing with this example, a sixth Security User Info field 1028-6 includes bits B102 to B112 of the MIC value (subfield 1054) followed by a disambiguation subfield 1056 set to 1 and the remaining bits B113 to B127 of the MIC value (subfield 1058). In this example, the remaining bits of the Security User Info field 1028-6 (subfield 1060) are reserved. In another example, separate PN+MIC values may be similarly arranged in the Security User Info List 1016 for each UHR STA addressed in the Trigger frame 1000.

FIG. 11 illustrates an example of a Trigger frame 1100 format including a Feedback User Info field with 28 bits carrying feedback information in accordance with embodiments of the present disclosure. The illustrated Trigger frame 1100 is similar in format to the Trigger frame 400 of FIG. 4, except that the Feedback User Info field(s) 1116 carries 28 bits of feedback information (e.g., unavailability information). Feedback information may include various feedback control information (unavailability information, <MCS, Nss, BW> of the recipient in the TXOP, etc.).

In the illustrated example, if Trigger frame protection is not required the PN+MIC value is omitted. In addition, multiple Feedback User Info fields 1116 may be included in Trigger frame 1100 to carry different types of feedback information, with each type of feedback information beginning in a new Feedback User Info field. Further, multiple Feedback User Info fields 1116 may be included to carry particular feedback information that exceeds 28 bits in length.

The Trigger frame 1100 of this example includes a MAC header 1102 having a Frame Control field 1104, a Duration field 1106, a RA field 1108, and a TA field 1110, a Common Info field 1112, a User Info List 1114, a Feedback User Info field 1116, an intermediate Frame Check Sequence (I-FCS) User Info List 1118, a Padding field 1120, and an FCS field 1122. In an example, the User Info List 1114 may include a Special User Info field 1124 and one or more User Info fields 1126-1 to 1126-N. The foregoing fields of Trigger frame 1100 generally correspond to the similarly labeled fields described with reference to FIG. 2.

In the illustrated example, the Feedback User Info field 1116 includes an AID12 subfield 1128 and a feedback subfield 1130 having 28 bits that carry a Feedback Type Identifier (ID) and feedback information. If a Trigger Dependent User Info subfield is also present, it is not used to carry feedback information, and may follow the same rules and include the same content as a Trigger Dependent User Info subfield of the Special User Info field 1124. In this example, the AID12 subfield 1128 carries a value that is used by a recipient device to identify a User Info field that carries feedback information. In an example, all types of feedback may be identified using the same AID12 value. In another example, when multiple Feedback User Info fields are required for one type of the feedback information, each Feedback User Info field may include a Feedback Type ID followed by the corresponding feedback information (or the remaining feedback information if one Feedback User Info field is not sufficient to carry the feedback information). Padding may be included in the last Feedback User Info field as necessary if multiple Feedback User Info fields are required for one type of the feedback information.

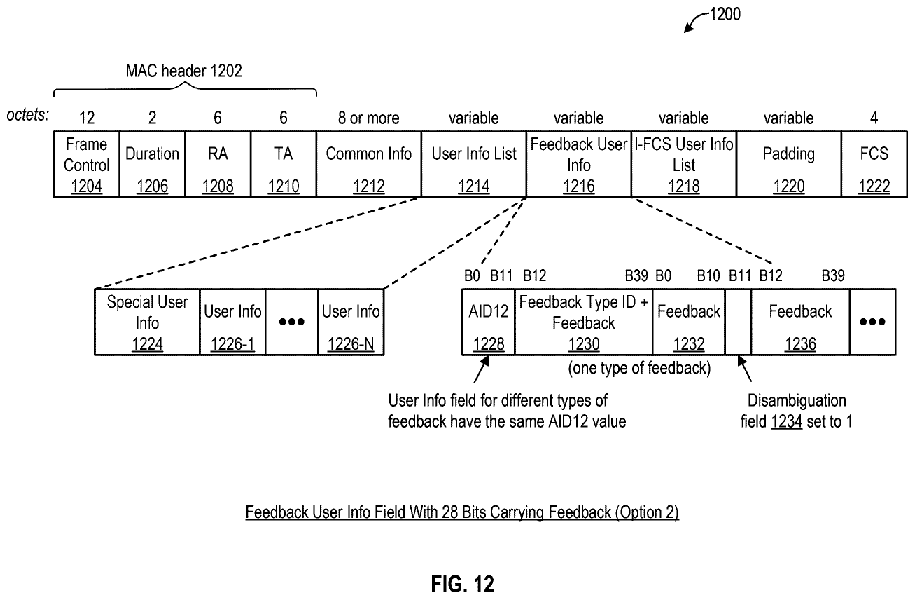

FIG. 12 illustrates an example of Trigger frame 1200 format including multiple Feedback User Info fields in accordance with embodiments of the present disclosure. The illustrated Trigger frame 1200 is similar in format to the Trigger frame 1100 of FIG. 11, except that the feedback information is carried in multiple Feedback User Info fields 1216 (e.g., using a disambiguation field for feedback information that exceeds 28 bits in length). In this example, if Trigger frame protection is not required the PN+MIC value is omitted.

The Trigger frame 1200 of this example includes a MAC header 1202 having a Frame Control field 1204, a Duration field 1206, a RA field 1208, and a TA field 1210, a Common Info field 1212, a User Info List 1214, a Feedback User Info field 1216, an intermediate Frame Check Sequence (I-FCS) User Info List 1218, a Padding field 1220, and an FCS field 1222. In an example, the User Info List 1214 may include a Special User Info field 1224 and one or more User Info fields 1226-1 to 1226-N. The foregoing fields of Trigger frame 1200 generally correspond to the similarly labeled fields described with reference to FIG. 2.

In the illustrated example, the Feedback User Info field 1216 includes an AID12 subfield 1228 and a feedback subfield 1230 having 28 bits that a carry a Feedback Type Identifier and feedback information. The Feedback User Info field 1216 of this example further includes at least one additional Feedback User Info field in which the first 11 bits (subfield 1232) are used to carry feedback information and bit 12 (subfield 1234) is utilized as a disambiguation subfield that is set 1 to indicate that the second Feedback User Info field carries additional feedback information. The second Feedback User Info field further includes up to 28 bits of the remaining feedback information (subfield 1236). In this example, the AID12 subfield 1228 carries a value that is used by a recipient device to identify a User Info field that carries feedback information.

In an example, all types of feedback carried by the Trigger frame 1200 may be identified using the same AID12 value. In another example, when multiple Feedback User Info fields are required, each Feedback User Info field may include a Feedback Type ID followed by the corresponding feedback information (or the remaining feedback information if one Feedback User Info field is not sufficient to the feedback information), and each different type of feedback begins in a new Feedback User Info field. Padding may be included in the last Feedback User Info field as necessary. In an example, if Trigger Dependent User Info subfields are also present, these subfields are not used to carry feedback information, and may follow the same rules and include the same content as a Trigger Dependent User Info subfield of the Special User Info field 1224.

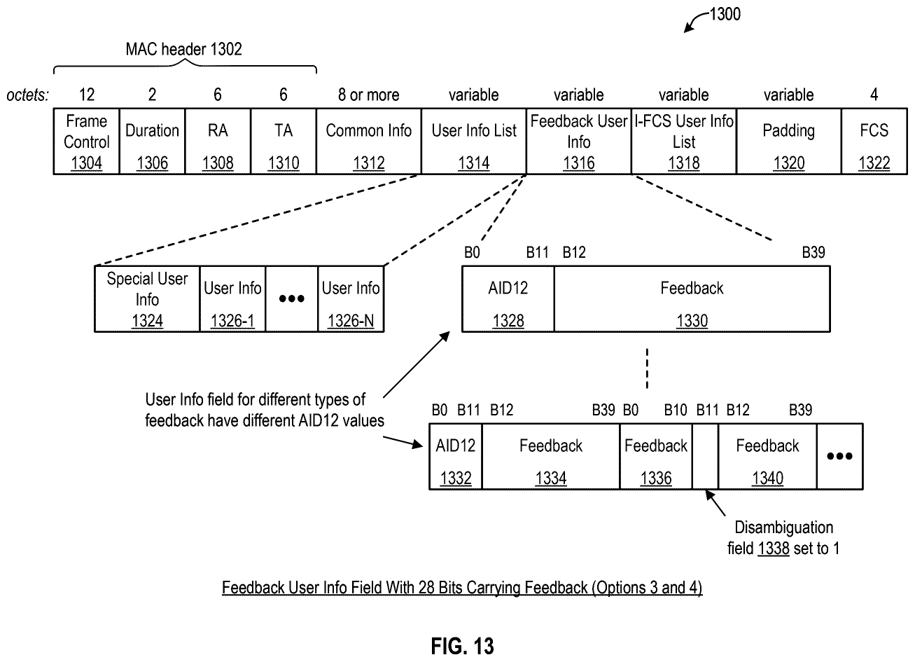

FIG. 13 illustrates additional examples of a Trigger frame 1300 format including one or more Feedback User Info field(s) carrying feedback information in accordance with embodiments of the present disclosure. The illustrated Trigger frame 1300 is similar in format to the Trigger frame 1100 of FIG. 11 and Trigger frame 1200 of FIG. 12, except that the User Info fields carrying different types of feedback information have different AID12 values.

The Trigger frame 1300 of this example includes a MAC header 1302 having a Frame Control field 1304, a Duration field 1306, a RA field 1308, and a TA field 1310, a Common Info field 1312, a User Info List 1314, a Feedback User Info field 1316, an intermediate Frame Check Sequence (I-FCS) User Info List 1318, a Padding field 1320, and an FCS field 1322. In an example, the User Info List 1314 may include a Special User Info field 1324 and one or more User Info fields 1326-1 to 1326-N. The foregoing fields of Trigger frame 1300 generally correspond to the similarly labeled fields described with reference to FIG. 2.

In the illustrated example, when a single Feedback User Info field 1316 is used to carry feedback information of a particular type, the Feedback User Info field 1316 includes an AID12 subfield 1328 having a value that identifies a particular type of feedback, and a feedback subfield 1330 having 28 bits that carry a the feedback information. If a Trigger Dependent User Info subfield is also present, it is not used to carry feedback information, and may follow the same rules and include the same content as a Trigger Dependent User Info subfield of the Special User Info field 1324. In this example, the AID12 subfield 1328 carries a value that is used by a recipient device to identify a User Info field that carries feedback information of a particular type.

In the illustrated example, when a multiple Feedback User Info fields 1316 are used to carry feedback information of a particular type, the first Feedback User Info field 1316 includes an AID12 subfield 1332 having a value that identifies a particular type of feedback, and a feedback subfield 1334 having 28 bits that a carry a portion of the feedback information. In this example, the feedback information is carried in at least one additional Feedback User Info field in which the first 11 bits (subfield 1336) are used to carry feedback information and bit 12 (subfield 1338) is utilized as a disambiguation subfield that is set 1 to indicate that the second Feedback User Info field carries an additional portion of the feedback information. The second Feedback User Info field further includes up to 28 bits of the remaining feedback information (subfield 1340). In this example, the AID12 subfield 1328 carries a value that is used by a recipient device to identify a User Info field that carries feedback information of a particular type (i.e., the Feedback Type ID is not required in the examples of FIG. 13).

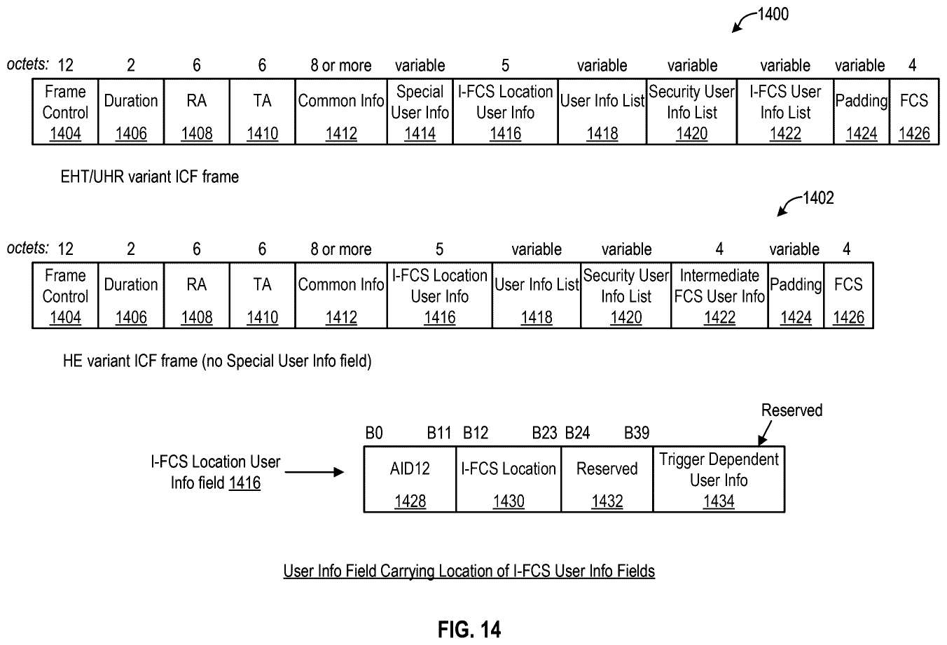

FIG. 14 illustrates examples of a Trigger frame format including an I-FCS Location User Info field in accordance with embodiments of the present disclosure. The I-FCS Location User Info field may be included, for example, when some STAs addressed by a Trigger support a protected Trigger frame while other STAs addressed by the Trigger frame do not support a protected Trigger frame.

In a first example, a Trigger frame 1400 includes a Frame Control field 1404, a Duration field 1406, a RA field 1408, a TA field 1410, a Common Info field 1412, a Special User Info field 1414, an I-FCS Location User Info field 1416, a User Info List 1418, a Security User Info List 1420, an intermediate Frame Check Sequence (I-FCS) User Info List 1422, a Padding field 1424, and an FCS field 1426. With the exception of the I-FCS Location User Info field 1416, the foregoing fields of Trigger frame 1400 generally correspond to the similarly labeled fields described with reference to FIG. 2. In a second example, a Trigger frame 1402 includes the same fields as the Trigger frame 1400, except the Special User Info field 1414 is omitted. In further examples, the Trigger frame 1400 is configured as an EHT/UHR variant ICF frame, and the Trigger frame 1402 is configured as a HE variant ICF frame (e.g., a Special User Info field is not defined in an HE variant Trigger frame).

In the illustrated example, the I-FCS Location User Info field 1416 of the Trigger frame 1400/1402 includes an AID12 subfield 1428, an I-FCS Location subfield 1430, and reserved bits B24 to B39 (subfield 1432). In some embodiments, the I-FCS Location User Info field 1416 may further include a Trigger Dependent User Info subfield 1434, which may be reserved.

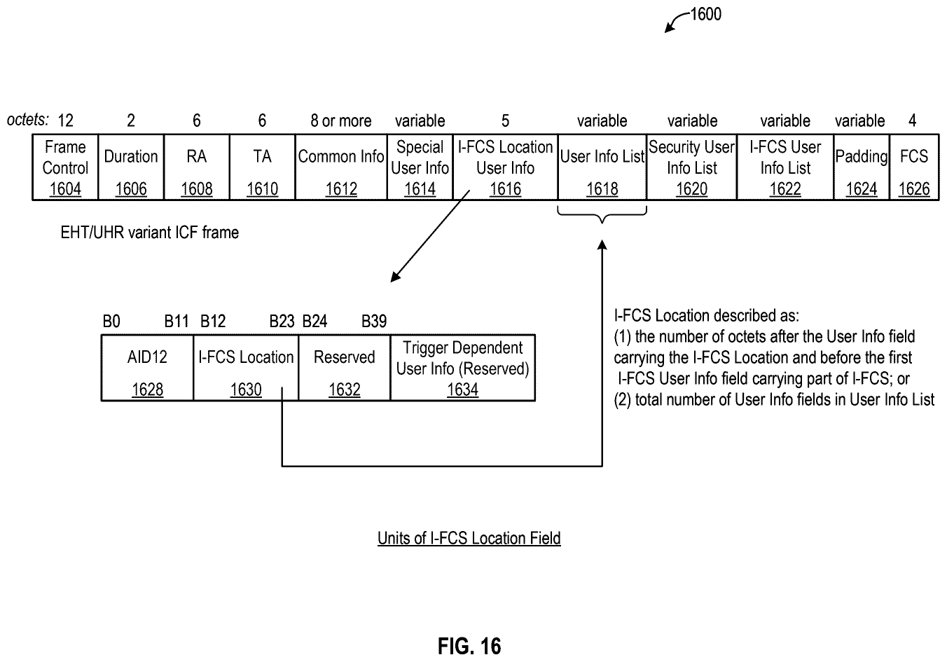

In an example, the I-FCS User Info field 1416 immediately precedes the User Info List 1418, and includes a 12 bit (or other length) value that can be used by a recipient device to determine the location of the I-FCS User Info List 1422. As described more fully in conjunction with FIG. 16, the location of the I-FCS User Info field may be expressed in either units of octets or a number of User Info fields (e.g., a number of User Info fields between the I-FCS Location User Info field 1416 and the beginning of the I-FCS User Info field 1422. In an example, the I-FCS Location User Info field 1416 has the same length as an EHT Special User Info field. In another example, the AID12 subfield 1428 may have the same value (e.g., 2007) as the AID12 subfield for the Special User Info field 1414. Alternatively, the AID12 subfield 1428 may have another predetermined value (e.g., 2006 or 2008) or range of values (e.g., greater than 2007). In other examples, when an Initial Control Frame (ICF) is transmitted by a non-AP STA, the location of an intermediate FCS User Info field may be fixed. Accordingly, in an uplink ICF transmitted by a non-AP STA to an associated AP, the I-FCS Location field may not be necessary.

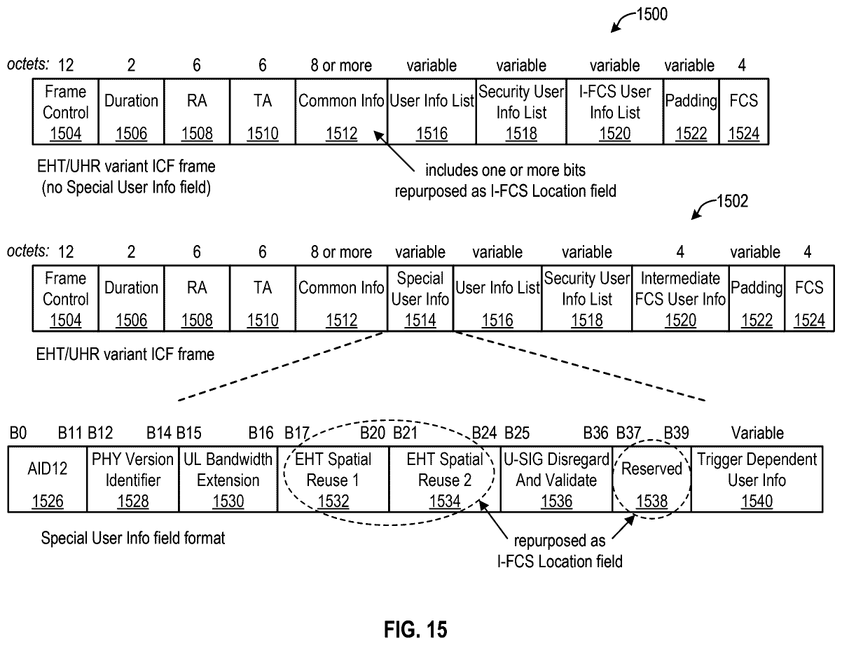

FIG. 15 illustrates examples of a Trigger frame format in which one or more bits of a Common Info field or Special User Info field are repurposed as an I-FCS Location field in accordance with embodiments of the present disclosure. In these examples, one or more currently reserved bits (or a reserved value in a field) of a Common Information field or Special User Information field of a Trigger frame (e.g., a BSRP Trigger frame) are defined to indicate the location of an I-FCS User Info field of the Trigger frame.

In a first example, a Trigger frame 1500 includes a Frame Control field 1504, a Duration field 1506, a RA field 1508, a TA field 1510, a Common Info field 1512, a User Info List 1516, a Security User Info List 1518, an intermediate Frame Check Sequence (I-FCS) User Info List 1520, a Padding field 1522, and an FCS field 1524. With the exception of the Common Info field 1512, the foregoing fields of Trigger frame 1500 generally correspond to the similarly labeled fields described with reference to FIG. 2. In this example, one or more bits of the Common Info field 1512 are repurposed as an I-FCS Location field.

In a second example, a Trigger frame 1502 includes the same fields as the Trigger frame 1500, except the Trigger frame 1502 further includes a Special User Info field 1514. A Special User Info field, introduced in 802.11be, is a User Info field that does not carry user specific information for an addressed STA but carries extended common information not provided in the Common Info field. When present, the Special User Info field is located immediately after the Common Info field of the Trigger frame, is generally of the same length as a User Info field, and carries information for the U-SIG field of a solicited EHT TB PPDU. In the example described below, one or more bits of the Special User Info field 1514 are repurposed/redefined as an I-FCS Location field.

The illustrated Special User Info field 1514 (e.g., a modified 802.11be Special User Info field) includes an AID12 subfield 1526 consisting of 12 bits, a PHY Version Identifier subfield 1528 consisting of 3 bits, a UL Bandwidth Extension subfield 1530 consisting of 2 bits, an EHT Spatial Reuse 1 subfield 1532 consisting of 4 bits, an EHT Spatial Reuse 2 subfield 1534 consisting of 4 bits, a U-SIG Disregard And Validate subfield 1536 consisting of 12 bits, a Reserved subfield 1538 consisting of 3 bits, and a Trigger Dependent User Info subfield 1540 of variable length. The PHY Version Identifier subfield 1528 may indicate the PHY version of the solicited TB PPDU that is not an HE TB PPDU (e.g., the PHY Version Identifier subfield is set to 0 for EHT, and may be set to another value to indicate UHR). In this example, one or more bits of the EHT Spatial Reuse 1 subfield 1532, EHT Spatial Reuse 2 subfield 1534 and/or Reserved subfield 1538 are redefined as an I-FCS Location field and, in further examples, to provide an indication of the existence of the I-FCS User Info field.

FIG. 16 illustrates examples of a Trigger frame 1600 format having an I-FCS Location User Info field in which the location of an I-FCS User Info field is expressed in units of octets or a number of User Info fields of a User Info List. In the illustrated example, a Trigger frame 1600 includes a Frame Control field 1604, a Duration field 1606, a RA field 1608, a TA field 1610, a Common Info field 1612, a Special User Info field 1614, an I-FCS Location User Info field 1616, a User Info List 1618, a Security User Info List 1620, an intermediate Frame Check Sequence (I-FCS) User Info List 1622 (e.g., two I-FCS User Info fields), a Padding field 1624, and an FCS field 1626. With the exception of the I-FCS Location User Info field 1616, the foregoing fields of Trigger frame 1600 generally correspond to the similarly labeled fields described with reference to FIG. 2. In an example, the Trigger frame 1600 is configured as an EHT/UHR variant ICF frame.

In the illustrated example, the I-FCS Location User Info field 1616 of the Trigger frame 1600 includes an AID12 subfield 1628, an I-FCS Location subfield 1630, and reserved bits B24 to B39 (subfield 1632). In some embodiments, the I-FCS Location User Info field 1616 may further include a Trigger Dependent User Info subfield 1634, which may be reserved. In this example, the I-FCS User Info field 1616 immediately precedes the User Info List 1618, and includes a 12 bit (or other length) value that can be used by a recipient device to determine the location of the I-FCS User Info List 1622.

Different types of Trigger frames may have User Info fields of varying lengths. For example, in a Multi-User Block Ack Request (MU-BAR) frame, the User Info fields addressed to different STAs may have different lengths. In an example that accommodates the differing lengths, the location of the I-FCS User Info field 1622 is expressed in units of octets, such as a number of octets after the I-FCS Location User Info field 1616 and before the first I-FCS User Info field carrying part of the I-FCS. In another example, the location of the I-FCS User Info field 1622 is expressed in a total number of User Info fields of the User Info List 1618 (e.g., a number of User Info fields between the I-FCS Location User Info field 1616 and the beginning of the I-FCS User Info field 1622).

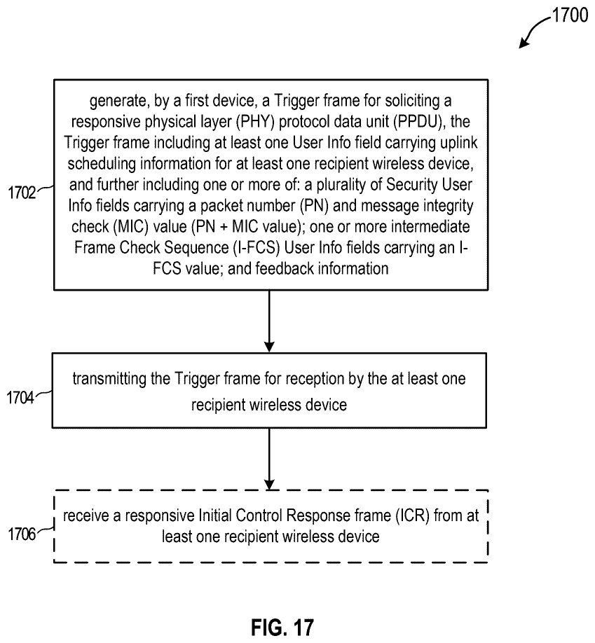

FIG. 17 is a flow chart illustrating an example method 1700 for generating a Trigger frame in accordance with embodiments of the present disclosure. The method 1700 can be performed by a first wireless communication device/access point (AP) or station (STA), such as an AP affiliated with AP MLD 102 described with reference to FIG. 1, a STA affiliated with a non-AP MLD, or the AP/STA 1800 described with reference to FIG. 18. The method 1700 may be utilized, for example, to generate Trigger frames such as described with reference to FIGS. 2-16.

The method begins at step 1702 where the AP/STA generates a Trigger frame for soliciting a responsive PPDU from at least one recipient wireless device. The Trigger frame includes at least one User Info field carrying uplink scheduling information for the least one recipient wireless device, and further includes one or more of: a plurality of Security User Info fields carrying a packet number (PN) and message integrity check (MIC) value (PN+MIC value); two intermediate Frame Check Sequence (I-FCS) User Info fields carrying an I-FCS value; and feedback information. For example, if the Trigger frame is a protected Trigger frame, it includes at least a PN+MIC value.

The method of this example continues at step 1704, where the AP/STA transmits the Trigger frame for reception by at least one recipient wireless device. In a further example, the Trigger frame is configured as an Initial Control Frame (ICF), and the method continues at step 1706 where the AP/STA receives a responsive Initial Control Response frame (ICR) from at least one recipient wireless device.

FIG. 18 illustrates an example of a wireless device 1800 that is configured as an access point (AP) or station (STA) according to an embodiment of the present disclosure. The AP/STA 1800 is configurable to generate and receive frame formats according to any of the various embodiments described herein, and to exchange dynamic (initial) control information with one or more other wireless devices. The illustrated AP/STA 1800 includes a host processor 1802 coupled to a network interface device 1804. The network interface device 1804 includes a medium access control (MAC) processing unit 1806 and a physical layer (PHY) processing unit 1808. The PHY processing unit 1808 includes a plurality of transceivers 1810 coupled to a plurality of antennas 1812. Although three transceivers 1810 (1810-1, 1810-2 and 1810-3) and three antennas 1812 (1812-1, 1812-2 and 1812-3) are illustrated in FIG. 1, the AP/STA 1800 includes other suitable numbers (e.g., 1, 2, 4, 5, etc.) of transceivers 1810 and antennas 1812 in other embodiments. In an example, the MAC processing unit 1806 and the PHY processing unit 1808 are configured to operate in compliance with the IEEE 802.11bn amendment to the IEEE 802.11 standard. In an example, the network interface device 1804 includes one or more integrated circuit (IC) devices. In this example, at least some of the functionality of the MAC processing unit 1806 and at least some of the functionality of the PHY processing unit 1808 can be implemented on a single IC device. As another example, at least some of the functionality of the MAC processing unit 1806 is implemented on a first IC device, and at least some of the functionality of the PHY processing unit 1808 is implemented on a second IC device. The AP/STA 1800 may communicate (e.g., Trigger-based communications) with a plurality of client stations and/or APs (not separately illustrated), including both legacy and non-legacy client APs and stations.

In various embodiments, the PHY processing unit 1808 of the AP/STA 1800 is configured to generate data units conforming to a non-legacy communication protocol and having formats described herein. The transceiver(s) 1810 is/are configured to transmit the generated data units via the antenna(s) 1812. Similarly, the transceiver(s) 1810 is/are configured to receive data units via the antenna(s) 1812. The PHY processing unit 1808 of the AP/STA 1800 is configured to process received data units conforming to the non-legacy communication protocol and having formats described herein and to determine that such data units conform to the non-legacy communication protocol.

In an embodiment, when operating as an AP in single-user mode, the AP/STA 1800 transmits an ICF or data unit to a single client station (DL SU transmission), or receives an ICR or data unit transmitted by a single client station (UL SU transmission), without simultaneous transmission to, or by, any other client station. When operating in multi-user mode, the AP/STA 1800 transmits a data unit that includes multiple data streams for multiple client stations (DL MU transmission), or receives data units simultaneously transmitted by multiple client stations (UL MU transmission). For example, in multi-user mode, a data unit transmitted by the AP includes multiple data streams simultaneously transmitted by the AP/STA 1800 to respective client stations using respective spatial streams allocated for simultaneous transmission to the respective client stations and/or using respective sets of OFDM tones corresponding to respective frequency sub-channels allocated for simultaneous transmission to the respective client stations. In a further example, the AP/STA 1800 may be configured as a multi-link device, such as the AP MLD 102 or STA MLD 104 described above with reference to FIG. 1.

While the innovate aspects of the present disclosure have been generally described in the context of the 802.11bn amendment, and future generations, of the IEEE 802.11 standard, a person having ordinary skill in the art will readily recognize that teachings herein may be applied to other wireless networks and standards including, for example, Long Term Evolution (LTE) standards and Bluetooth standards.

The innovative methods and apparatus illustrated in the drawings and described herein provide for Trigger frame formats that can carry a variety of information (e.g., security and feedback information) in specialized User Info fields. In an illustrative, non-limiting embodiment, a method for wireless communication is provided. The method includes generating, by a first device, a Trigger frame for soliciting a responsive physical layer (PHY) protocol data unit (PPDU). In this method, the Trigger frame includes at least one User Info field carrying uplink scheduling information for at least one recipient wireless device. The Trigger frame further includes a plurality of Security User Info fields carrying a packet number (PN) and message integrity check (MIC) value (PN+MIC value). The method further includes transmitting the Trigger frame for reception by the at least one recipient wireless device.

The method of this embodiment includes optional aspects. With one optional aspect, the Trigger frame further includes two intermediate Frame Check Sequence (I-FCS) User Info fields carrying an I-FCS value. With another optional aspect, the Trigger frame further includes a Special User Info field. In yet another optional aspect, the Special User Info field includes a first Trigger Dependent User Info subfield, and a Security User Info field of the plurality of Security User Info fields includes a second Trigger Dependent User Info subfield that carries the same information as the first Trigger Dependent User Info subfield.

In another optional aspect, a first Security User Info field of the plurality of Security User Info fields includes an AID12 subfield having at least 12 bits set to a predetermined value that indicates the first Security User Info field carries a portion of the PN+MIC value. In a further optional aspect, the PN and the MIC value are carried in separate Security User Info fields of the plurality of Security User Info fields. With another optional aspect, the plurality of Security User Info fields include at least one Security User Info field in which bits B12 to B15 are reserved.

In another optional aspect, the Trigger frame further includes two intermediate Frame Check Sequence (I-FCS) User Info fields carrying an I-FCS value and an I-FCS Location User Info field, wherein the I-FCS Location User Info field includes an indication of the location of the I-FCS User Info fields. In yet another optional aspect, the I-FCS Location User Info fields immediately precede the at least one User Info field and includes an association ID (AID) subfield having a value greater than 2007, and the indication of the location of the I-FCS User Info fields is expressed in either units of octets or a number of User Info fields. In a further optional aspect, the Trigger frame further includes a Common User Info field and at least one intermediate Frame Check Sequence (I-FCS) User Info field carrying an I-FCS value, wherein one or more bits of the Common User Info field are redefined to indicate a location of the at least one I-FCS User Info field.

With another illustrative, non-limiting embodiment, a method for wireless communication is provided. The method includes generating, by a first device, a Trigger frame for soliciting a responsive physical layer (PHY) protocol data unit (PPDU). In this method, the Trigger frame includes at least one User Info field carrying uplink scheduling information for at least one recipient wireless device. The Trigger frame further includes at least one intermediate Frame Check Sequence (I-FCS) User Info field carrying an I-FCS value and a Feedback User Info field carrying feedback information of the first device. The method further includes transmitting the Trigger frame for reception by the at least one recipient wireless device.

This embodiment includes optional aspects. With one optional aspect, the Feedback User Info field includes an association ID (AID) subfield having an AID value that indicates the Feedback User Info field includes the feedback information. In another optional aspect, the Trigger frame is an Initial Control Frame (ICF), and wherein the Feedback User Info field further includes a Feedback Type ID subfield that identifies a type of the feedback information. In still another optional aspect, the Feedback User Info field carries a first type of feedback information, and the Trigger frame further comprises at least one additional Feedback User Info field carrying a second type of feedback information.

With another illustrative, non-limiting embodiment, a communication device includes one or more wireless transceivers and one or more processors operably coupled to the one or more wireless transceivers. The one or more processing modules are arranged to generate a Trigger frame including at least one User Info field carrying uplink scheduling information for at least one recipient wireless device. The Trigger frame further includes a plurality of Security User Info fields carrying a packet number (PN) and message integrity check (MIC) value (PN+MIC value). The one or more processing modules of the communication device are further arranged to transmit the Trigger frame, via the one or more wireless transceivers, for reception by the at least one recipient wireless device.

This third embodiment includes optional aspects. With one optional aspect, the Trigger frame further includes at least one intermediate Frame Check Sequence (I-FCS) User Info field carrying an I-FCS value. In another optional aspect, the Trigger frame further includes an I-FCS Location User Info field, wherein the I-FCS Location User Info field includes an indication of the location of the at least one I-FCS User Info field. In a further optional aspect, the I-FCS Location User Info field immediately precedes the at least one User Info field and includes an association ID (AID) subfield having a value greater than 2007, and wherein the indication of the location of the at least one I-FCS User Info field is expressed in either units of octets or a number of User Info fields. In another optional aspect, a first Security User Info field of the plurality of Security User Info fields includes an association ID (AID) subfield having at least 8 bits set to a predetermined value that indicates the first Security User Info field carries a portion of the PN+MIC value. In yet another optional aspect, the Trigger frame further includes at least one Feedback User Info field carrying a Feedback Type ID subfield and feedback information of the communication device.

To implement various operations described herein, computer program code (i.e., program instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks. The program instructions may also be loaded onto a processing core, processing circuitry, computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

As may be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may be further used herein, the terms “common” and/or “common part” may refer to a shared or combined component(s), element(s), circuit(s), module(s), and/or information field(s), and such terms are not intended to imply or suggest “known in the art”.

As may further be used herein, the term(s) “arranged to”, “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with” includes direct and/or indirect coupling of separate items and/or one item being embedded within another item.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processor”, “processing circuitry”, “processing circuit”, “processing module”, and/or “processing unit” may be a single processing device or a plurality of processing devices. Such a processing device may be a microprocessor, microcontroller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. Further, such a processing device may include a plurality of processing cores or processing domains, which may operate on separate power domains. The processor, processing circuitry, processing circuit, processing module, and/or processing unit may be (or may further include) memory and/or an integrated memory element, which may be a single memory device, a plurality of memory devices, and/or embedded circuitry of another processor, processing circuitry, processing circuit, processing module, and/or processing unit. Such a memory device may be a read-only memory, random access memory, volatile memory, non-volatile memory, static memory, dynamic memory, flash memory, cache memory, and/or any device that stores digital information. Note that if the processor, processing circuitry, processing circuit, processing module, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processor, processing circuitry, processing circuit, processing module, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processor, processing circuitry, processing circuit, processing module, and/or processing unit executes, hard coded and/or operational instructions corresponding to at least some of the steps and/or functions illustrated in one or more of the figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims.

To the extent used, the logic diagram block boundaries and sequence could have been defined otherwise and still perform the certain significant functionality. Such alternate definitions of both functional building blocks and logic diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors/processing cores executing appropriate software and the like or any combination thereof.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

The term “module” may be used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for wireless communication, comprising:
generating, by a first device, a Trigger frame for soliciting a responsive physical layer (PHY) protocol data unit (PPDU), the Trigger frame including:
at least one User Info field carrying uplink scheduling information for at least one recipient wireless device; and
a plurality of Security User Info fields, the plurality of Security User Info fields carrying a packet number (PN) and message integrity check (MIC) value (PN+MIC value); and
transmitting the Trigger frame for reception by the at least one recipient wireless device.

2. The method of claim 1, wherein the Trigger frame further includes two intermediate Frame Check Sequence (I-FCS) User Info fields carrying an I-FCS value.

3. The method of claim 1, wherein the Trigger frame further includes a Special User Info field.

4. The method of claim 3, wherein the Special User Info field includes a first Trigger Dependent User Info subfield, and wherein a Security User Info field of the plurality of Security User Info fields includes a second Trigger Dependent User Info subfield that carries the same information as the first Trigger Dependent User Info subfield.

5. The method of claim 1, wherein a first Security User Info field of the plurality of Security User Info fields includes an AID12 subfield having 12 bits set to a predetermined value that indicates the first Security User Info field carries a portion of the PN+MIC value.

6. The method of claim 5, wherein the PN and MIC value are carried in separate Security User Info fields of the plurality of Security User Info fields.

7. The method of claim 5, wherein the plurality of Security User Info fields include at least one Security User Info field in which bits B12 to B15 are reserved.

8. The method of claim 1, wherein the Trigger frame further includes two intermediate Frame Check Sequence (I-FCS) User Info fields carrying an I-FCS value and an I-FCS Location User Info field, wherein the I-FCS Location User Info field includes an indication of the location of the two I-FCS User Info fields.

9. The method of claim 8, wherein the I-FCS Location User Info field immediately precedes the at least one User Info field and includes an association ID (AID) subfield having a value greater than 2007, and wherein the indication of the location of the two I-FCS User Info fields is expressed in either units of octets or a number of User Info fields.

10. The method of claim 1, wherein the Trigger frame further includes a Common User Info field and at least one intermediate Frame Check Sequence (I-FCS) User Info field carrying an I-FCS value, wherein one or more bits of the Common User Info field are redefined to indicate a location of the at least one I-FCS User Info field.

11. A method for wireless communication, comprising:
generating, by a first device, a Trigger frame for soliciting a responsive physical layer (PHY) protocol data unit (PPDU), the Trigger frame including:
at least one User Info field carrying uplink scheduling information for at least one recipient wireless device;
at least one intermediate Frame Check Sequence (I-FCS) User Info field carrying an I-FCS value; and
a Feedback User Info field carrying feedback information of the first device; and
transmitting the Trigger frame for reception by the at least one recipient wireless device.

12. The method of claim 11, wherein the Feedback User Info field includes an association ID (AID) subfield having an AID value that indicates the Feedback User Info field includes the feedback information.

13. The method of claim 12, wherein the Trigger frame is an Initial Control Frame (ICF), and wherein the Feedback User Info field further includes a Feedback Type ID subfield that identifies a type of the feedback information.

14. The method of claim 12, wherein the Feedback User Info field carries a first type of feedback information, the Trigger frame further comprises at least one additional Feedback User Info field carrying a second type of feedback information.

15. A communication device, comprising:
one or more wireless transceivers; and
one or more processors operably coupled to the one or more wireless transceivers, wherein the one or more processors are arranged to:
generate a Trigger frame, the Trigger frame including:
at least one User Info field carrying uplink scheduling information for at least one recipient wireless device; and
a plurality of Security User Info fields, the plurality of Security User Info fields carrying a packet number (PN) and message integrity check (MIC) value (PN+MIC value); and
transmit, via the one or more wireless transceivers, the Trigger frame for reception by the at least one recipient wireless device.

16. The communication device of claim 15, wherein the Trigger frame further includes at least one intermediate Frame Check Sequence (I-FCS) User Info field carrying an I-FCS value.

17. The communication device of claim 16, wherein the Trigger frame further includes an I-FCS Location User Info field, wherein the I-FCS Location User Info field includes an indication of the location of the at least one I-FCS User Info field.

18. The communication device of claim 17, wherein the I-FCS Location User Info field immediately precedes the at least one User Info field and includes an association ID (AID) subfield having a value greater than 2007, and wherein the indication of the location of the at least one I-FCS User Info field is expressed in either units of octets or a number of User Info fields.

19. The communication device of claim 15, wherein a first Security User Info field of the plurality of Security User Info fields includes an association ID (AID) subfield having at least 8 bits set to a predetermined value that indicates the first Security User Info field carries a portion of the PN+MIC value.

20. The communication device of claim 19, wherein the Trigger frame further includes at least one Feedback User Info field carrying a Feedback Type ID subfield and feedback information of the communication device.
